(19) United States
(12) Patent Application Publication
(10) Pub. No.: US 2017/0265463 A1
(43) Pub. Date: Sep. 21, 2017

(54) SPORICIDAL COMPOSITION

(71) Applicant: CASE WESTERN RESERVE UNIVERSITY, Cleveland, OH (US)

(72) Inventors: Curtis Donskey, Cleveland, OH (US); Michelle Nerandzic, Cleveland, OH (US)

(21) Appl. No.: 15/459,899

(22) Filed: Mar. 15, 2017

Related U.S. Application Data
(60) Provisional application No. 62/308,516, filed on Mar. 15, 2016.

(51) Int. Cl. A01N 31/02; A01N 37/36

(52) U.S. Cl. CPC A01N 31/02; A01N 37/36

(57) ABSTRACT

A sporicidal composition includes an acidified short or medium chain, linear or branched alcohol having a pH effective to promote killing of spore forming bacteria and bacterial spores.

### RELATED APPLICATION

This application claims priority from U.S. Provisional Application No. 62/308,516, filed Mar. 15, 2016, the subject matter of which is incorporated herein by reference in its entirety.

### BACKGROUND

Clostridium difficile is an important cause of infections in hospitals, nursing homes, and in the community. It causes about 500,000 infections and 14,000 deaths each year in the United States. C. difficile forms spores that are the major source of transmission. The spores are commonly spread through contamination of environmental surfaces or the hands of healthcare workers. Although there are effective methods to kill C. difficile spores on environmental surfaces (e.g., bleach), there are currently no effective and safe methods to kill spores on the hands of healthcare workers.

Vegetative C. difficile can only survive 15 minutes aerobically, but the bacteria are nonetheless very difficult to eradicate because they form spores. C. difficile spores can be found as airborne particles, attached to inanimate surfaces such as hard surfaces and fabrics, and attached to surfaces of living organisms, such as skin and hair. Spores can be found on a patient's skin as well as on any surface in the room that the infected patient occupied. During exams these spores can be transferred to the hands and body of healthcare workers and thereby spread to subsequent equipment and areas they contact.

People are most often infected in hospitals, nursing homes, or institutions, although C. difficile infection in the community, outpatient setting is increasing. C. difficile infection (CDI) can range in severity from asymptomatic to severe and life-threatening, especially among the elderly. The rate of C. difficile acquisition is estimated to be 13% in patients with hospital stays of up to 2 weeks, and 50% in those with hospital stays longer than 4 weeks.

While currently available antibiotics used for treatment of recurrent spore-forming C. difficile-associated diseases (CDAD) lead to symptomatic improvement, they are essentially ineffective against C. difficile spores, the transmissible form of the disease. This causes a high risk of relapse occurring post-therapy as sporulated microorganisms begin to germinate. Therefore, controlling C. difficile infection requires limiting the spread of spores by good hygiene practices, isolation and barrier precautions, and environmental cleaning.

### SUMMARY

Embodiments described herein relate to alcohol based sporicidal compositions that can be used, for example, as hand sanitizers, antiseptic agents, disinfecting agents, or cleansing agents, to kill bacterial spores on tissue surfaces or non-tissue environmental surfaces. It was found that acidification of alcohols induces rapid sporicidal activity against C. difficile, and to a lesser extent Bacillus spp. spores. The alcohol based sporicidal compositions can include short or medium chain, linear or branched alcohols, such as ethanol, that exhibit antimicrobial or bactericidal properties. The alcohol can be provided in the composition at amounts of at least about 50 wt. %, 60 wt. %, 70 wt. %, 80 wt. %, or 90 wt. % or more. The pH of the composition can be such that spore inner membrane permeability is disrupted. In some embodiments, the composition can have a pH from about 2 to less than about 3.5, or about 2 to less than about 3, or about 3.1 to less than about 3.5.

In other embodiments, the sporicidal activity of acidified ethanol can be enhanced by modifications including increased ionic strength, modest elevation in temperature (e.g., 42° C.), and the addition of dilute peracetic acid. Moreover, the addition of dilute peracetic acid can expand the spectrum of activity, resulting is potent synergistic activity against Bacillus spp. spores in addition to C. difficile spores.

Both in a porcine skin model and on hands of healthy adults, acidified sporicidal alcohol formulations were found to be as effective as soap and water hand washing in achieving rapid reduction in C. difficile spores. The acidified alcohol based sporicidal compositions can be developed into effective hand sanitizer and patient bathing products. Moreover, the sporicidal compositions can be used for sporicidal skin disinfectants whereby existing disinfectants are converted into sporicidal agents through benign modifications that facilitate access to the spore core. Finally, the sporicidal compositions may also be useful for environmental disinfection or disinfection of devices that are not able to be autoclaved (e.g., endoscopes).

In some embodiments, the sporicidal composition can be applied to a C. difficile spores-contaminated surface to reduce the number of and/or kill C. difficile spores on the surface. In some embodiments, the spore-contaminated surface is part of a piece of furniture, table or countertop, floor, wall, bath or lavatory surfaces, bedclothes, and linens. In other embodiments, the spore-contaminated surface is human skin. In still other embodiments, the spore-contaminated surface is part of a medical device or instrument.

In some embodiments, application of the sporicidal composition to the spore-contaminated surface is by immersion bath, wiping or washing.

### BRIEF DESCRIPTION OF THE DRAWINGS

FIG. 1 illustrates the effect of pH alteration on the spore killing potential of ethanol. Six log₁₀colony-forming units (CFU) of Clostridium difficile, Bacillus thuringiensis, and Bacillus subtilis spores were exposed to 70% ethanol solutions adjusted to pH<2.2 or >11 for 5 minutes at room temperature. Log₁₀CFU reduction of spores was determined by calculating the difference in log₁₀CFU recovered from baseline (pH altered water) and experimental groups (pH altered ethanol). The means of data from triplicate experiments are presented. Error bars indicate standard error.

FIG. 2A illustrates the effect of elevated temperature on the spore killing potential of ethanol. Six log₁₀colony-forming units (CFU) of Clostridium difficile, Bacillus thuringiensis, and Bacillus subtilis spores were exposed to 70% ethanol solutions at 55° C. or 80° C. for 5, 10, 20, 30 or 60 minutes. Log₁₀CFU reduction of spores was determined by calculating the difference in log₁₀CFU recovered from baseline (temperature altered water) and experimental groups (temperature altered ethanol). The means of data from triplicate experiments are presented. Error bars indicate standard error.

FIG. 2B illustrates the effect of mild temperature elevation and increased ionic strength on the sporicidal activity of acidified ethanol. Six log₁₀ colony forming units (CFU) of Clostridium difficile were exposed to 70% ethanol at room temperature (22° C.) and at 42° C. for 1 or 10 minutes. Acidified ethanol solutions were adjusted to 3.0, 2.0, 2.5, and 1.5 with hydrochloric acid (HCl). Additionally, the acidified ethanol solutions were buffered with incremental quantities of sodium hydroxide (NaOH), yielding solutions with increasing ionic strength (increments labeled “*” to “****”, from lowest to highest ionic strength, respectively). Log₁₀CFU reduction of spores was determined by calculating the difference in log₁₀CFU recovered from baseline (pH altered water at room temperature) and experimental groups. The means of data from triplicate experiments are presented. Error bars indicate standard error.

FIG. 3 illustrates the synergistic effect of dilute peracetic acid on the sporicidal activity of acidified ethanol. Six log₁₀ colony forming units (CFU) of Clostridium difficile and Bacillus subtilis spores were exposed to 450, 650, or 1500 ppm peracetic acid with or without the addition of pH altered (2.5 and 1.5) or unaltered 70% ethanol at room temperature for 3 minutes. Log₁₀CFU reduction of spores was determined by calculating the difference in log₁₀CFU recovered from baseline (pH altered water at room temperature) and experimental groups. The means of data from triplicate experiments are presented. Error bars indicate standard error.

FIG. 4 illustrates the release of dipicolinic acid (DPA) from Clostridium difficile, Bacillus thuringiensis, and Bacillus subtilis spores. Seven log₁₀ colony forming units (CFU) of spores were exposed to test solutions and supernatants were mixed 1:1 with terbium chloride solution after 1, 5, and 10 minutes of incubation at room temperature (˜22° C.). DPA release was monitored by distinctive fluorescence emission of the terbium-DPA complex. Percent DPA release was determined by comparing relative fluorescence units (RFU) of test solutions to the RFU of total spore DPA content (supernatant of 7 log₁₀CFU spores suspended in water boiled for 30 minutes).

FIG. 5A illustrates the comparison of soap and water hand wash versus acidified ethanol solutions for removal of non-toxigenic Clostridium difficile spores from the finger pads of volunteers. One milliliter of test solution was applied with rubbing to contaminated finger pads. For soap and water hand wash, 1 mL of soap was applied to finger pads, rubbed for 20 seconds, rinsed, and then patted dry with paper towels. Log₁₀CFU reduction of spores was determined by calculating the difference in log₁₀CFU recovered from treated versus untreated finger pads. The means of data from triplicate experiments are presented. Error bars indicate standard error.

FIG. 5B illustrates the comparison of soap and water hand wash versus dilute peracetic acid containing solutions for removal of non-toxigenic Clostridium difficile spores from the finger pads of volunteers. One milliliter of test solution was applied with rubbing to contaminated finger pads. For soap and water hand wash, 1 mL of soap was applied to finger pads, rubbed for 20 seconds, rinsed, and then patted dry with paper towels. Log₁₀CFU reduction of spores was determined by calculating the difference in log₁₀CFU recovered from treated versus untreated finger pads. The means of data from triplicate experiments are presented. Error bars indicate standard error.

FIG. 6 illustrates the effectiveness of the sporicidal alcohol formulation for removal of C. difficile spores from gloves.

FIG. 7A is a comparison of the spore killing efficacy of three acidified alcohols. Six log₁₀ colony forming units (CFU) of Clostridium difficile spores were exposed to 70% ethanol, 70% 1-propanol, or 70% 2-propanol solutions adjusted to pH 1.5 for 5 minutes at room temperature. Log₁₀CFU reduction of spores was determined by calculating the difference in log₁₀CFU recovered from baseline (pH altered water) and experimental groups (pH altered ethanol). The means of the data from experiments conducted in triplicate are presented. Error bars indicate standard error.

FIG. 7B is a comparison of the spore killing efficacy of ethanol acidified with organic and inorganic acids. Six log₁₀ colony forming units (CFU) of Clostridium difficile spores were exposed to 70% ethanol adjusted to pH 1.5 with hydrochloric acid, sulfuric acid, citric acid, or lactic acid and incubated for 5 minutes at room temperature. Log₁₀CFU reduction of spores was determined by calculating the difference in log₁₀CFU recovered from baseline (pH altered water) and experimental groups (pH altered ethanol). The means of the data from experiments conducted in triplicate are presented. Error bars indicate standard error.

FIG. 8 illustrates the effect of temperature elevation on the sporicidal activity of acidified ethanol. Six log₁₀ colony forming units (CFU) of Clostridium difficile, Bacillus thuringiensis, and Bacillus subtilis spores were exposed to 70% ethanol solution adjusted to pH 1.5 and incubated at 22° C., 55° C. or 80° C. for 5 minutes. Log₁₀CFU reduction of spores was determined by calculating the difference in log₁₀CFU recovered from baseline (pH altered water) and experimental groups (pH altered ethanol). The means of the data from experiments conducted in triplicate are presented. Error bars indicate standard error.

FIG. 9 is a comparison of soap and water wash versus acidified ethanol solutions for removal of Clostridium difficile spores from porcine skin sections. Fifty microliters of each formulation was pipetted onto an inoculated section of porcine skin and rubbed for 30 seconds with a second inoculated section of porcine skin. To simulate a soap and water hand wash, 50 microliters of soap was pipetted onto an inoculated section of porcine skin and rubbed for 20 seconds with a second inoculated section. Both sections were rinsed with running tap water until soap was removed, and then patted dry on paper towels. Log₁₀CFU reduction of spores was determined by calculating the difference in log₁₀CFU recovered from treated versus untreated porcine skin sections. The means of the data from experiments conducted in triplicate are presented. Error bars indicate standard error.

FIG. 10 illustrates that acidification induces sporicidal activity in ethanol. Six log₁₀colony-forming units (CFU) of C. difficile (VA17, VA11, and ATCC 43593) and B. subtilis spores were exposed to 70% ethanol solutions adjusted to pH 0.8 to 4 for 5 minutes at room temperature. Log₁₀CFU reduction of spores was determined by calculating the difference in log₁₀CFU recovered from baseline (pH altered water) and experimental groups (pH altered ethanol). The means of data from triplicate experiments are presented. Error bars indicate standard error.

FIG. 11 illustrates that ethanol enhances the sporicidal efficacy of dilute peracetic acid. Six log₁₀ colony forming units (CFU) of C. difficile (VA17 and ATCC 43593) spores were exposed to aqueous and alcoholic peracetic acid solutions (450 ppm) and incubated at room temperature for 3 or 10 minutes. The pH of the solutions was either left unadjusted (pH 3.5) or lowered to 3.0, 2.5, 2.0, 1.5, or 1.0. Log₁₀CFU reduction of spores was determined by calculating the difference in log₁₀CFU recovered from baseline (water) and experimental groups. The means of data from triplicate experiments are presented. Error bars indicate standard error.

FIG. 12 illustrates that acidified ethanol and peracetic acid exert synergistic sporicidal activity against C. difficile and B. subtilis spores in vitro. Six log₁₀colony-forming units (CFU) of C. difficile (VA17) and B. subtilis spores were exposed to peracetic acid alone (450, 650, and 1500 ppm) or in combination with 70% ethanol and reduced pH (unadjusted, 2.5, and 1.5). Spores suspensions were incubated at room temperature for 3. Log₁₀CFU reduction of spores was determined by calculating the difference in log₁₀CFU recovered from baseline (water) and experimental groups. The means of data from triplicate experiments are presented. Error bars indicate standard error.

FIG. 13 illustrates that acidified ethanol and peracetic acid reduce levels of non-toxigenic C. difficile (ATCC 43593) spores on skin. One milliliter of test solution was applied with rubbing to contaminated finger pads. For soap and water hand wash, 1 mL of soap was applied to finger pads, rubbed for 20 seconds, rinsed, and then patted dry with paper towels. Log10CFU reduction of spores was determined by calculating the difference in log₁₀CFU recovered from treated versus untreated finger pads. The means of data from triplicate experiments are presented. Error bars indicate standard error.

### DETAILED DESCRIPTION

Embodiments described herein relate to alcohol based sporicidal compositions that can be used, for example, as hand sanitizers, antiseptic agents, disinfecting agents, or cleansing agents, to kill bacterial spores on tissue surfaces or non-tissue environmental surfaces. It was found that acidification of alcohols induces rapid sporicidal activity against C. difficile, and to a lesser extent Bacillus spp. spores.

In some embodiments, the alcohol based sporicidal compositions can include short or medium chain, linear or branched alcohols, such as ethanol, that exhibit antimicrobial or bactericidal properties. In another embodiment, the composition includes a short chain alcohol having one to three carbons. In still another embodiment, the composition includes ethanol. In some embodiments, the composition includes propanol (e.g., 1-propanol and 2-propanol). In yet other embodiments, the composition can include longer chain alcohols having between six and eighteen carbons. The long chain alcohols can be linear or branched.

The alcohol can be provided in the composition at amounts of at least about 30 wt. %, 40 wt. %, 50 wt. %, 60 wt. %, 70 wt. %, 80 wt. %, or 90 wt. % or more. In some embodiments, the alcohol is provided in the composition at about 70 wt. % or more.

In some embodiments, the composition includes an acidified alcohol. The pH of the composition can be such that bacterial spore inner membrane barrier permeability is disrupted upon contact with the composition. Dormant spores' inner membrane barrier permeability disruption can be identified through assay detection of the release of spore specific small molecules like dipicolinic acid (DPA).

In some embodiments, the composition can have a pH less than about 4, less than about 3.5, less than about 3, less than about 2.5, or less than about 2. In some embodiments, the composition can have a pH that is tolerable on human skin. Thus, in certain embodiments, the pH is greater than about pH 1.5. In a particular embodiment, the composition can have a pH of from 1.5 to less than about 3.5, from about 2 to less than about 3.5, or about 2 to less than about 3, about 1.5 to about 2.5, or about 3.1 to less than about 3.5.

Alcohols for use in a composition described herein to induce sporicidal activity can be acidified through the addition of one or more inorganic and organic acids, including but not limited to hydrochloric acid, sulfuric, lactic, and citric acids. In certain embodiments the acidification of alcohol includes the use of hydrochloric acid. Further pH adjustment can be achieved using sodium hydroxide (NaOH) to obtain a desired range of pHs.

In other embodiments, the sporicidal activity of acidified alcohol can be enhanced by modifications including increased ionic strength, modest elevation in temperature (e.g., 42° C.), and the addition of dilute peracetic acid. Peracetic acid, also referred to herein as PAA, is an ideal antimicrobial agent due to its high oxidizing potential. It is broadly effective against microorganisms and is not deactivated by catalase and peroxidase, the enzymes, which break down hydrogen peroxide. The addition of dilute peracetic acid can expand the spectrum of activity, resulting is potent synergistic activity against Bacillus spp. spores in addition to C. difficile spores.

In some embodiments, the peracetic acid can be provided in the sporicidal composition at a concentration of about 250 ppm to about 2500 ppm, for example, about 450 ppm to about 2000 ppm, about 450 ppm to about 1500, or about 450 ppm to about 650 ppm. The addition of acidified ethanol to 450 and 650 ppm peracetic acid significantly enhanced killing of C. difficile and B. subtilis spores by >2 log₁₀CFU and >1 log₁₀CFU respectively, whereas peracetic acid with the addition of acid or ethanol alone did not similarly enhance killing (P<0.001 for each comparison)

The sporicidal composition can further include additional solvents, such as water and/or additional organic solvent besides the alcohol. The organic solvents can be a single organic liquid or a mixture of two or more organic liquids. Examples of organic solvents can include glycols, such as ethylene glycol (1,2-ethanediol), propylene glycols (1,2-propanediol (“propylene glycol”); 1,3-propanediol), butylene glycols, (1,2-butanediol (“butylene glycol”); 1,3-butanediol; 1,4-butanediol; 2,3-butanediol), diethylene glycol (bis(2-hydroxyethyl) ether), and the like; glycerine; glycol ethers, such as ethylene glycol monomethyl ether, ethylene glycol monoethyl ether, ethylene glycol monopropyl ether, ethylene glycol monoisopropyl ether, ethylene glycol monobutyl ether, ethylene glycol monophenyl ether, ethylene glycol monobenzyl ether, diethylene glycol monomethyl ether, diethylene glycol monoethyl ether, diethylene glycol mono-n-butyl ether, ethylene glycol dimethyl ether, ethylene glycol diethyl ether, ethylene glycol dibutyl ether, and the like; polyethylene glycols, such as PEG-200 and PEG-400; and dimethyl isosorbide.

In some embodiments, the organic solvent is glycerine, a glycol, or a mixture thereof. In some embodiments, the organic solvent is glycerine. In some embodiments, the organic solvent is a glycol. In some embodiments, the organic solvent is glycerine, propylene glycol, butylene glycol, or a mixture of two or more of these. In some embodiments, the organic solvent is a mixture of glycerine and propylene glycol. In some embodiments, the organic solvent is a mixture of glycerine and butylene glycol. In some embodiments, the organic solvent is a mixture of propylene glycol and butylene glycol. In some embodiments, the organic solvent is propylene glycol. In some embodiments, the organic solvent is butylene glycol.

The sporicidal composition described herein may be used in combination with a product. The sporicidal composition may be formulated with one or more conventional pharmaceutically-acceptable and compatible carrier materials to form a personal care delivery composition. The personal care delivery composition may take a variety of forms including, without limitation, aqueous solutions, gels, balms, lotions, suspensions, creams, milks, salves, ointments, sprays, foams, solid sticks, and aerosols.

In some embodiments, the composition can include one or more skin conditioning agents. Skin conditioning agents include, for example, moisturizers and barriers. Moisturizers or humectants are additives that attract moisture to the outer layers of skin to keep it moist and supple. Barriers prevent moisture already present in the skin from being lost. Examples of skin conditioning agents include, but are not limited to, the following: glycerol, propylene glycol, sorbitol, aloe vera, lanolin or lanolin-derivatives, petrolatum, sqaulene, cetostearyl alcohol, beeswax, tricaprylin, glyceryl cocoate, isopropyl myristate, isopropyl palmitate, cetyl alcohol, stearyl alcohol, mineral oil, shea butter, safflower oil, and other moisturizers and barriers known to those of skill in the art. Other skin conditioning agents, such as vitamins, anti-oxidants and other skin health compounds can also be included in the composition. Additionally, skin treatment and or anti-irritant compounds, including allantoin, trioctanoin, niacinamide, methyl sulphone, and lactose can also be included in the formulations.

In some embodiments, the composition can include one or more surfactants. The surfactant can be a non-ionic surfactant, an anionic surfactant, or a cationic surfactant. In some embodiments, a combination of surfactants may be used. In one embodiment, the surfactant is a non-ionic surfactant. In one embodiment, the surfactant is an anionic surfactant. Examples of surfactants include, but are not limited to, the following: nonylphenol ethoxylates, alcohol ethoxylates, alcohol alkylates, sorbitan ester ethoxylates, ethoxylated alkyl-polyglucosides, alkyl ether carboxylates, fatty alcohols, ceteth-20, Octyldodeceth-20, Oleth-35, Glycereth-18, Polysorbate 20, PEG-200 Castor Oil, PEG-80 glyceral cocoate (Hetoxide GC-80), sodium lauryl sulfate, ammonium lauryl sulfate, and ethylene oxide-propylene oxide copolymers. Other surfactants known to those of skill in the art may also be used. In one embodiment, the surfactant is a non-ionic surfactant.

In some embodiments, the composition can include one or more thickening agents. Examples of thickening agents include, but are not limited to, the following: polyvinylpyrrolidone, xanthan gum, guar gum, clay, sodium alginate, methylcellulose, hydroxypropylcellulose, hydroxypropylmethylcellulose, carboxymethylcellulose, anionic carboxyvinyl polymers, hydroxymethylcellulose, and Carbomer 940 or 980. Other thickening agents known to those of skill in the art may also be used. In some instances, emulsifying waxes may be used to thicken the composition without the need for additional thickening agents.

In some embodiments, one or more fragrances can be used to mask the odor of the PAA in the composition. The selected fragrances should be compatible with PAA. Exemplary fragrances suitable for use with PAA include, but are not limited to, the following: cuminaldehyde, cinnamic aldehyde, thymol, cineole, and piperonal. Several fragrances available from Wellington Fragrance of Livonia, Mich. have also been found to be suitable for use with PAA. These Wellington fragrances include: Rain Forest, Blackberry Sage Tea, Chai Tea, Dewberry, Dogwood, Plumeria, Tranquility, Cucumber Melon, Blackberry, Merlot, Neroli-Cedar, Sage & Chamomile, and Fresh Cotton. Any fragrance suitable for use with PAA can be included in the composition.

The various sproricidal compositions described above according to the various embodiments can include any number of additional components typically found in cosmetic formulations including solubilizers, emulsifyers, emollients and other components known to those of skill in the art. Additionally, it is generally recognized that some ingredients may serve a dual function, for example, some components may serve as both a surfactant and/or an emulsifier. In some instances, some components may serve as an emulsifier, a surfactant and/or a solubilizer. PEG-80 glyceral cocoate (Hetoxide GC-80) is an example of one such component that is capable of serving as an emulsifier, surfactant and/or solubilizer.

Examples of other optional and/or additional components include penetrants, chelating agents, anti-foaming reagents, corrosion inhibitors, dyes, fragrances, and other desired components.

Examples of penetrants include, but are not limited to, laurocapram, fatty alcohol ethoxylates, and menthol.

Examples of chelating agents that may be employed in the sporicidal composition include, but are not limited to, BDTA (N,N′-1,4-butanediylbis[N-(carboxymethyl)]glycine), EDTA (ethylenediaminetetraacetic acid), various ionized forms of EDTA, EGTA (N″-ursodeoxycholyl-diethylenetriamine-N,N,N′-triacetic acid), PDTA (N,N′-1,3-propanediylbis[N-(carboxymethyl)]glycine), TTHA (3,6,9,12-tetraazatetradecanedioic acid, 3,6,9,12-tetrakis(carboxymethyl)), trisodium HEDTA (N-[2[bis(carboxymethyl) amino]ethyl]-N-(2-hydroxyethyl)-glycine, trisodium salt), sometimes known as Versenol 120. Numerous other chelating agents known in the arts may also optionally be employed.

Anti-foaming reagents that may be used in the sporicidal composition described herein include, but are not limited to, such as Merpol A (commercially available from Stepan), polyethylene glycol and dimethyl polysiloxanes.

Examples of suitable corrosion inhibitors that may be employed in the sporicidal composition include, but are not limited to, ascorbic acid, benzoic acid, benzoimidazole, citric acid, 1H-benzotriazole, 1-hydroxy-1H-benzotriazole, phosphate, phosphonic acid, pyridine, and sodium benzoate. Numerous other corrosion inhibitors known in the arts may also optionally be employed.

Examples of suitable dyes that may be employed in the sporicidal composition include, but are not limited to, Blue 1 (Brilliant Blue FCF) if a bluish color is desired, D&C Green No. 5, D&C Green No. 6, and D&C Green No. 8, if a greenish color is desired, Yellow No. 5 if a yellowish color is desired, etc. Numerous other dyes known in the arts may also optionally be employed.

The acidified alcohol based sporicidal compositions can be developed into effective hand sanitizer and patient bathing products. Moreover, the sporicidal compositions can be used for sporicidal skin disinfectants whereby existing disinfectants are converted into sporicidal agents through benign modifications that facilitate access to the spore core.

In other embodiments, the sporicidal composition may be incorporated into or onto a substrate, such as a wipe substrate, an absorbent substrate, a fabric or cloth substrate, or a tissue substrate, among others. For example, the sporicidal composition may be incorporated into cleansing products, such as wipes, absorbent articles, cloths, cleaning articles, and the like. More particularly, the sporicidal composition may be incorporated into wipes, such as wet wipes, dry wipes, hand wipes, face wipes, cosmetic wipes, and the like. In one embodiment, the sporicidal composition is a liquid composition that may be used in combination with a wipe substrate to form a wet wipe, or may be a wetting composition for use in combination with a dispersible wet wipe.

In other embodiments, the sporicidal composition may be incorporated into compositions and wipes to improve the sporicidal efficacy of these products. Generally, the wipes including the sporicidal composition can be wet wipes or dry wipes. As used herein, the term “wet wipe” means a wipe that includes greater than about 70 percent (by weight substrate) liquid content. As used herein, the term “dry wipe” means a wipe that includes less than about 10 percent (by weight substrate) liquid content. Specifically, suitable wipes for use of the sporicidal composition described herein can include wet wipes, dry wipes, hand wipes, face wipes, cosmetic wipes, household wipes, industrial wipes, and the like. Particularly preferred wipes are wet wipes, and other wipe-types that include a solution.

Materials suitable for the substrate of the wipes are well known to those skilled in the art, and are typically made from a fibrous sheet material, which may be either woven or nonwoven. For example, suitable materials for use in the wipes may include nonwoven fibrous sheet materials, which include meltblown, coform, air-laid, bonded-carded web materials, hydroentangled materials, and combinations thereof. Such materials can contain synthetic or natural fibers, or a combination thereof.

In one particular embodiment, the wipes may be a coform basesheet of polymer fibers and absorbent fibers. Typically, such coform basesheets contain a gas-formed matrix of thermoplastic polymeric meltblown fibers and cellulosic fibers. Various suitable materials may be used to provide the polymeric meltblown fibers, such as, for example, polypropylene microfibers. Alternatively, the polymeric meltblown fibers may be elastomeric polymer fibers, such as those provided by a polymer resin. For instance, Vistamaxx.™ elastic olefin copolymer resin designated PLTD-1810, available from ExxonMobil Corporation (Houston, Tex.) or KRATON G-2755, available from Kraton Polymers (Houston, Tex.) may be used to provide stretchable polymeric meltblown fibers for the coform basesheets. Other suitable polymeric materials, or combinations thereof, may alternatively be utilized as known to those skilled in the art.

The coform basesheet additionally may contain various absorbent cellulosic fibers, for example, wood pulp fibers. Suitable commercially available cellulosic fibers for use in the coform basesheets can include, for example, NF 405, which is a chemically treated bleached southern softwood Kraft pulp, available from Weyerhaeuser Co. (Federal Way, Wash.); NB 416, which is a bleached southern softwood Kraft pulp, available from Weyerhaeuser Co.; CR-0056, which is a fully debonded softwood pulp, available from Bowater, Inc. (Greenville, S.C.); Golden Isles 4822 debonded softwood pulp, available from Koch Cellulose (Brunswick, Ga.); and SULPHATATE HJ, which is a chemically modified hardwood pulp, available from Rayonier, Inc. (Jesup, Ga.).

In another embodiment, the wipe substrate may be an airlaid nonwoven fabric. The basis weights for airlaid nonwoven fabrics may range from about 20 to about 200 grams per square meter with staple fibers having a denier of about 0.5-10 and a length of about 6 to about 15 millimeters. Processes for producing airlaid nonwoven basesheets are described in, for example, published U.S. Pat. App. No. 2006/0008621, herein incorporated by reference.

In an alternative embodiment, the wipes may be a composite, which includes multiple layers of materials. For example, the wipes may include a three layer composite, which includes an elastomeric film or meltblown layer between two coform layers as described above. In such a configuration, the coform layers may define a basis weight of from about 15 to about 30 grams per square meter and the elastomeric layer may include a film material such as a polyethylene metallocene film. Such composites are manufactured generally as described in U.S. Pat. No. 6,946,413, issued to Lange, et al., which is hereby incorporated by reference to the extent it is consistent herewith.

As mentioned above, one type of wipe suitable for use in combination with the sporicidal composition is a wet wipe. In addition to the wipe substrate, wet wipes also contain a liquid composition. The liquid composition can be any liquid, which can be absorbed into the wet wipe basesheet and may include any suitable components, which provide the desired wiping properties. For example, the components may include water, emollients, surfactants, fragrances, preservatives, organic or inorganic acids, chelating agents, pH buffers, or combinations thereof, as are well known to those skilled in the art. Further, the liquid may also contain lotions, medicaments, and/or antimicrobials.

The wet wipe composition may desirably be incorporated into the wipe in an add-on amount of from about 10 to about 600 percent (by weight of the treated substrate), more desirably from about 50 to about 500 percent (by weight of the treated substrate), even more desirably from about 100 to about 400 percent (by weight of the treated substrate), and especially more desirably from about 200 to 300 percent (by weight of the treated substrate).

In another embodiment, the wipe is a dry wipe. In this embodiment, the wipe can be wetted with the sporicidal composition just prior to, or at the point of, use of the wipe. Alternately, the dry wipe may be prepared by applying by any suitable means (e.g., spraying, impregnating, etc.) a composition comprising a sporicidal composition described herein onto a wipe substrate. The composition may contain 100 percent of the sporicidal composition, or alternately, the sporicidal composition may be present in the composition in combination with a carrier. In embodiments where the sporicidal composition used to prepare the dry wipe contains water or moisture, the resulting treated substrate is then dried so that the wipe contains less than about 10 percent (by weight substrate) moisture content, and a dry wipe is produced. The treated substrate can be dried by any means known to those skilled in the art including, for example by use of convection ovens, radiant heat sources, microwave ovens, forced air ovens, and heated rollers or cans, or combinations thereof.

The dry wipe may contain the sporicidal composition in an add-on amount composition of from about 40 to about 250 percent (by weight of the treated substrate), more desirably about 100 percent (by weight of the treated substrate).

The wipe substrate incorporating the sporicidal composition described herein may be used to clean various different kinds of surfaces either in a clinical or other type of setting. These may include, for instance, various desk, table or countertops or other parts of furniture surfaces, bath and lavatory surfaces, floor and wall surfaces, or medical instruments. The sporicidal composition may also be employed in a bath or rinse to wash medical instruments, linens, bedclothes, or human skin. The sporicidal composition may even be incorporated and used in a disinfecting or sanitary solution to wash hands or medical instruments.

Finally, the sporicidal compositions may also be useful for environmental disinfection or disinfection of medical devices. A medical device can include any instrument, implement, machine, contrivance, implant, or other similar or related article, including a component or part, or accessory which is recognized in the official U.S. National Formulary the U.S. Pharmacopoeia, or any supplement thereof; intended for use in the diagnosis of disease or other conditions, or in the cure, mitigation, treatment, or prevention of disease, in humans or in other animals; or, intended to affect the structure or any function of the body of humans or other animals, and which does not achieve any of its primary intended purposes through chemical action within or on the body of human or other animal, and which is not dependent upon being metabolized for the achievement of any of its primary intended purposes.

A medical device can include, for example, endovascular medical devices, such as intracoronary medical devices. Examples of intracoronary medical devices can include stents, drug delivery catheters, grafts, and drug delivery balloons utilized in the vasculature of a subject. Where the medical device comprises a stent, the stent may include peripheral stents, peripheral coronary stents, degradable coronary stents, non-degradable coronary stents, self-expanding stents, balloon-expanded stents, and esophageal stents. The medical device may also include arterio-venous grafts, by-pass grafts, penile implants, vascular implants and grafts, intravenous catheters, small diameter grafts, surgical mesh, artificial lung catheters, electrophysiology catheters, bone pins, suture anchors, blood pressure and stent graft catheters, breast implants, benign prostatic hyperplasia and prostate cancer implants, bone repair/augmentation devices, breast implants, orthopedic joint implants, dental implants, implanted drug infusion tubes, oncological implants, pain management implants, neurological catheters, central venous access catheters, catheter cuff, vascular access catheters, urological catheters/implants, atherectomy catheters, clot extraction catheters, PTA catheters, PTCA catheters, stylets (vascular and non-vascular), drug infusion catheters, angiographic catheters, hemodialysis catheters, neurovascular balloon catheters, thoracic cavity suction drainage catheters, electrophysiology catheters, stroke therapy catheters, abscess drainage catheters, biliary drainage products, dialysis catheters, central venous access catheters, and parental feeding catheters.

The medical device may additionally include either arterial or venous pacemakers, vascular grafts, sphincter devices, urethral devices, bladder devices, renal devices, gastroenteral and anastomotic devices, vertebral disks, hemostatic barriers, clamps, surgical staples/sutures/screws/plates/wires/clips, glucose sensors, blood oxygenator tubing, blood oxygenator membranes, blood bags, birth control/IUDs and associated pregnancy control devices, cartilage repair devices, orthopedic fracture repairs, tissue scaffolds, CSF shunts, dental fracture repair devices, intravitreal drug delivery devices, nerve regeneration conduits, electrostimulation leads, spinal/orthopedic repair devices, wound dressings, embolic protection filters, abdominal aortic aneurysm grafts and devices, neuroaneurysm treatment coils, hemodialysis devices, uterine bleeding patches, anastomotic closures, aneurysm exclusion devices, neuropatches, vena cava filters, urinary dilators, endoscopic surgical and wound drainings, bandages, surgical tissue extractors, transition sheaths and dialators, coronary and peripheral guidewires, circulatory support systems, tympanostomy vent tubes, cerebro-spinal fluid shunts, defibrillator leads, percutaneous closure devices, drainage tubes, bronchial tubes, vascular coils, vascular protection devices, vascular intervention devices including vascular filters and distal support devices and emboli filter/entrapment aids, AV access grafts, surgical tampons, and cardiac valves.

The invention is further illustrated by the following example, which is not intended to limit the scope of the claims.

### EXAMPLE 1

In this Example, we show that alteration of physical and chemical conditions (e.g., acid or alkaline pH and elevated temperature) can induce rapid sporicidal activity of alcohol against C. difficile, and to a lesser extent Bacillus spp. spores, both in vitro and on skin. The sporicidal activity of acidified ethanol was enhanced by increasing ionic strength and mild elevations in temperature and the addition of low concentrations of peracetic acid resulted in synergistic killing of C. difficile and Bacillus spp. spores. Sporicidal formulations of acidified ethanol stimulated release of dipicolinic acid, suggesting that the mechanism of spore killing may involve disruption of spore inner membrane permeability. On hands and in an ex vivo porcine skin model, sporicidal ethanol formulations were as effective as soap and water washing in achieving rapid reduction in levels of C. difficile spores. This report demonstrates the potential for development of new ethanol-based sporicidal hand hygiene formulations through modifications that facilitate access to the spore core.

### METHODS

### Spore Strains and Growth Conditions

Two C. difficile strains cultured from patients with CDI in Cleveland and one strain purchased from the American Type Culture Collection (ATCC) were used. VA 17 is an epidemic (cdtB+) restriction endonuclease analysis (REA) BI strain and VA 11 is a non-epidemic (cdtB−) REA J strain; both isolates are toxigenic (tcdA+, tcdB+) strains. ATCC 43593 is a non-toxigenic (tcdA, tcdB−) strain from serogroup B. C. difficile cultures were incubated at 37° C. for 48 hours in a Whitley MG1000 anaerobic workstation (Microbiology International, Frederick, Md.) on pre-reduced cycloserine-cefoxitin-brucella agar containing 0.1% taurocholic acid and lysozyme 5 mg/L (CDBA). The Institutional Review Board of the Cleveland VA Medical Center approved the study protocol for collection of the patient isolates.

Two Bacillus species were used for in vitro studies. A well characterized strain of Bacillus subtilis (strain 168 containing plasmid pUB110 carrying a gene for kanamycin resistance) was donated by Peter Setlow (UConn Health Center, Farmington, Conn.). A strain of Bacillus thuringiensis (ATCC 55173) was also assessed. Bacillus spores were cultured on trypticase soy agar (TSA) containing 5% sheep blood (Becton, Dickinson and Company, Franklin Lakes, N.J.) under aerobic conditions at 37° C. for 24 hours

### Preparation of Spores

C. difficile and B. thuringiensis spores were prepared as previously described. In brief, pre-reduced brain-heart infusion (BHIS) plates were spread with 100 μl of a 24 hour C. difficile or B. thuringiensis suspension and incubated for one week in an anaerobic or aerobic incubator, respectively. Spores were harvested from the plates using sterile swabs and 8 mL of ice-cold, sterile, distilled water. Spores were washed five times by centrifuging at 15,000×g for 5 min and re-suspending in distilled water. Spores were separated from vegetative material by density gradient centrifugation in histodenz (Sigma Aldrich, St. Louis, Mo.). Spores were stored at 4° C. in sterile distilled water until use. Prior to testing, spore preps were confirmed by phase contrast microscopy and malachite green staining to be >99% dormant, bright-phase spores.

Bacillus subtilis spores were prepared at 37° C. on 2×SG medium agar plates and harvested, cleaned, and stored as previously described. Spores were separated from vegetative material by density gradient centrifugation in nycodenz (Axis-Shield, Oslo, Norway). Spores were confirmed by phase contrast microscopy and malachite green staining to be >99% dormant, bright-phase spores.

### Effect of Altered pH on Sporicidal Activity of Alcohol

To determine the effect of altered pH on the sporicidal efficacy of ethanol, the pH of 70% ethanol and deionized water was adjusted with hydrochloric acid (HCl) or sodium hydroxide (NaOH) to obtain a range of pHs from 1.3 to >11. Ten microliters of spores (˜10⁶ CFU) were incubated for five minutes in one mL of the pH adjusted ethanol or water (baseline) at ˜22° C. (room temperature). B. subtilis, B. thuringiensis, and three strains of C. difficile spores were tested (described above in Spore Strains and Growth Conditions). The reaction was quenched by neutralizing 1:1 in Dey-Engley neutralization broth (BD Biosciences, San Jose, Calif., USA). Neutralized samples were serial diluted in deionized water, drop-plated, and cultured as described above in Spore Strains and Growth Conditions. Following incubation, log10CFU reduction of spores was determined by calculating the difference in log₁₀CFU recovered from baseline (pH altered water) and experimental groups (pH altered ethanol). Similar experiments were conducted to assess whether acidification of 1-propanol and 2-propanol to pH 1.5 would result in similar induction of sporicidal activity. In addition, other inorganic and organic acids, including sulfuric, lactic, and citric acids were assessed for their ability to induce sporicidal activity in ethanol.

### Effect of Increased Temperature on Sporicidal Activity of Ethanol Without pH Alteration

To determine the effect of elevated temperature on the sporicidal efficacy of ethanol, ten microliters of spores (˜10⁶ CFU) were incubated in one mL of 70% ethanol or deionized water at about 22° C. (room temperature), 55° C. or 80° C. The pH was not altered for these experiments. B. subtilis, B. thuringiensis, and VA11 and VA17 C. difficile spores were tested (described above in Spore Strains and Growth Conditions). After 0, 5, 10, 20, 30 and 60 minutes of incubation at the appropriate temperature, aliquots of each spore suspension were serial diluted in deionized water, drop-plated, and cultured as described above in Spore Strains and Growth Conditions. Log₁₀CFU reduction of spores was determined by calculating the difference in log₁₀CFU recovered from baseline (spores incubated in water) and experimental groups (spores incubated in ethanol).

### Effect of Increased Temperature on Sporicidal Activity of Acidified Ethanol

To assess the effect of increased temperature on sporicidal activity of acidified ethanol, the pH of 70% ethanol and deionized water was adjusted to 1.5 with hydrochloric acid (HCl). Ten microliters of spores (about 10⁶ CFU) were inoculated into one mL of the pH adjusted ethanol or water (baseline) and incubated at about 22° C., 55° C. or 80° C. for five minutes. B. subtilis, B. thuringiensis, and three strains of C. difficile spores were tested (described above in Spore Strains and Growth Conditions). The reaction was quenched by neutralizing 1:1 in Dey-Engley neutralization broth (BD Biosciences, San Jose, Calif., USA). Neutralized samples were serial diluted in deionized water, drop-plated, and cultured as described above in Spore Strains and Growth Conditions. Following incubation, log₁₀CFU reduction of spores was determined by calculating the difference in log₁₀CFU recovered from baseline (pH altered water) and experimental groups (pH altered ethanol).

Effect of Mild Temperature Elevation and Increased Ionic Strength on Sporicidal Activity of Acidified Ethanol Against C. difficile

We assessed the effect of increased ionic strength on the sporicidal activity of acidified ethanol against C. difficile (strains VA11 and VA17) at room temperature (22° C.) and at 42° C., a moderate temperature that is tolerable on skin. The pH of 70% ethanol was adjusted to 3.0, 2.0, 2.5, and 1.5 with hydrochloric acid (HCl). Additionally, the acidified ethanol solutions were buffered with incremental quantities of sodium hydroxide (NaOH), yielding solutions with increasing ionic strength. Ten microliters of spores (˜10⁶ CFU) were inoculated into one mL of the pH adjusted ethanol, ethanol (without altered pH), or water (baseline) and incubated in a water bath at 22° C. or 42° C. in for one and ten minutes. The reaction was quenched by neutralizing 1:1 in Dey-Engley neutralization broth (BD Biosciences, San Jose, Calif., USA). Neutralized samples were serial diluted in deionized water, drop-plated, and cultured. Following incubation, log₁₀CFU reduction of spores was determined by calculating the difference in log₁₀CFU recovered from baseline (pH altered water) and experimental groups (pH altered ethanol). Experiments were performed in triplicate.

### Effect of Addition of Dilute Peracetic Acid on Sporicidal Activity of Acidified Ethanol

The effect of addition of peracetic acid on activity of acidified ethanol against C. difficile (VA17) and B. subtilis was tested at room temperature (about 22° C.). The pH of specified test solutions was adjusted to 2.5 or 1.5 with hydrochloric acid (HCl). Ten microliters of spores (about 10⁶ CFU) were inoculated into one mL of water (baseline), pH adjusted ethanol, peracetic acid at 450, 650, or 1500 ppm, pH adjusted peracetic acid at 450 and 650 ppm, ethanol plus peracetic acid at 450 and 650 ppm, and pH adjusted ethanol plus peracetic acid at 450 and 650 ppm. Spore suspensions were incubated at room temperature for three minutes. The reaction was quenched by neutralizing 1:1 in Dey-Engley neutralization broth (BD Biosciences). Neutralized samples were serial diluted in deionized water, drop-plated, and cultured. Following incubation, log₁₀CFU reduction of spores was determined by calculating the difference in log₁₀CFU recovered from baseline (water) and experimental groups. Experiments were performed in triplicate.

### Mechanisms of Spore Killing by Acidified Ethanol Solutions

To assess whether acidified ethanol truly kills spores or only renders them incapable of germination, recovery of killed spores was assessed by incubation in lysozyme or dodecylamine which bypass germinant receptors. To assess whether acidified ethanol kills spores through alteration in the permeability of the dormant spores' inner membrane barrier, we evaluated whether spore killing occurs in parallel with dipicolinic acid (DPA) release. C. difficile (VA17), B. thuringiensis and B. subtilis spores were suspended in water, water altered to pH 1.5, 70% ethanol, 70% ethanol altered to pH 1.5, 3.0 or 3.0 with increased ionic strength, and 1 mM dodecylamine (induces DPA release in spores of several species). After 1, 5, and 10 minutes of incubation at room temperature (about 22° C.), DPA release was assessed as previously described. In brief, 100 μl of the centrifuged spore suspensions were mixed with 100 μl terbium chloride solution (TbCl3, 30 μM) in opaque 96-well microtiter plates (in 8 replicates). Fluorescence was measured using a plate reader (SpectraMaxM2, Bucher Biotec, Basel, Switzerland) with the following settings: time resolved fluorescence (delay 50 μs, interval 1200 μs) at an excitation wavelength of 272 nm, emission wavelength of 545 nm, and 5 endpoint readings per sample at 22° C. To determine percent DPA release, relative fluorescence units (RFU) of test solutions were compared to the RFU of total spore DPA content (supernatant of 10⁷ CFU spores suspended in water boiled for 30 minutes) as previously described.

Efficacy of Acidified Ethanol Solutions for Reducing C. difficile Spores on Hands

A modification of the “Standard Test Method for Determining the Bacteria-Eliminating Effectiveness of Hygienic Handwash and Handrub Agents Using the Fingerpads of Adults” (American Society for Testing and Materials E 2276-10) was used to determine the efficacy of test solutions against non-toxigenic C. difficile spores. Each fingerpad of both hands were contaminated with 10 μL of a liquid inoculum containing 6 log₁₀CFU of ATCC 43593 spores. The fingerpads were rubbed together until the inoculum was dry. Hand contamination levels were measured using the fingerpad sampling method. In brief, the fingerpads of each hand were rubbed with slight friction against the bottom of a 150 mm×15 mm Petri dish filled with 25 mL of Dey-Engley neutralizer (BD Biosciences, San Jose, Calif., USA) for 30 seconds. The neutralizer was collected from the Petri dish, serially diluted 10-fold, and plated on CDBA media to determine C. difficile counts. Log₁₀ reductions were calculated by subtracting log₁₀ CFU recovered after hand hygiene treatment from log₁₀ CFU recovered from hands without treatment.

A crossover design was used such that each volunteer was exposed to three of the disinfection procedures. The order of the hand disinfection procedures for each volunteer was assigned using a computer-generated random numbers list designed to allow all agents or procedures to be tested in triplicate. The person reading the plates to quantify spore counts was blinded to the test product that was used. In initial studies, the hand disinfection interventions included 1 mL ethanol-based hand sanitizer gel (Purell, GOJO Industries, Akron, Ohio), 1 mL of 0.05% triclosan liquid soap (STERIS Corporation, Mentor, Ohio), 1 mL of 10% household bleach solution, and 1 mL of the following acidified ethanol solutions: 70% ethanol (unaltered pH ˜5.6), 70% ethanol pH 1.3, 70% ethanol pH 1.5, 70% ethanol pH 2.0, and 70% ethanol pH 2.0 with high ionic strength (buffered with hydrochloric acid and soldium hydroxide). For the soap and water handwash, fingerpads were rubbed vigorously with liquid soap for 20 sec, rinsed with water until soap was completely removed, and patted dry with paper towels. For the bleach and ethanol-based handrub agents, fingerpads were rubbed together with the agent until they appeared dry.

Similar experiments were conducted to assess the efficacy of dilute peracetic acid-containing solutions and acidified ethanol solutions at 42° C. For the peracetic acid experiment, the following acidified ethanol solutions were tested: 70% ethanol (unaltered pH ˜5.6), 70% ethanol pH 1.5, peracetic acid 450 ppm, peracetic acid 450 ppm pH 1.5, 70% ethanol pH 1.5 with peracetic acid 450 ppm, and 70% ethanol pH 2 with peracetic acid 450 ppm. To test acidified ethanol solutions at 42° C., the solutions were placed in a closed container in a 42° C. water bath or in the same closed container at 22° C. and contaminated fingerpads were submersed for 30 seconds and rubbed together. Reductions in spore counts were then determined as described previously.

Efficacy of Acidified Ethanol for Reducing C. difficile Spores in an Ex Vivo Porcine Skin Model

To allow an assessment of the efficacy of acidified ethanol in reducing toxigenic C. difficile spores on skin, an ex vivo porcine skin model was used. A modified version of ASTM E2897 “Standard Guide for Evaluation of the Effectiveness of Hand Hygiene Topical Antimicrobial Products using ex vivo Porcine Skin” was used. In brief, gamma irradiated porcine skin, stored at −80° C., was thawed and cut into 1.5 cm² sections. Ten microliters (˜10⁶ CFU) of C. difficile spores (VA 17 and VA11) were inoculated onto each section and spread to cover the surface of the skin.

The skin disinfection formulations included ethanol-based hand sanitizer (Purell, GOJO Industries, Akron, Ohio), 0.05% triclosan liquid soap (STERIS Corporation, Mentor, Ohio), 10% bleach solution (The Clorox Company, Oakland, Calif.), 70% ethanol adjusted to pH 1.3, 1.5 and 2.0 with HCl, and 70% ethanol adjusted to pH 2.0 with HCl buffered with NaOH (increased ionic strength). To simulate a soap and water hand wash, 50 microliters of soap was pipetted onto an inoculated section of porcine skin and rubbed for 20 seconds with a second inoculated section. Both sections were rinsed with running tap water until soap was removed, and then patted dry on paper towels. For all other formulations, 50 microliters of each skin disinfection formulation was pipetted onto an inoculated section of porcine skin and rubbed for 30 seconds with a second inoculated section of porcine skin. Following skin disinfection procedures, both sections were placed into a tube containing 10 mL of Dey-Engley neutralizer and vortexed for 2 minutes. Suspensions were serial diluted, drop-plated, and cultured as described above in Spore Strains and Growth Conditions. Following incubation, log₁₀CFU reduction of spores was determined by calculating the difference in log₁₀CFU recovered from baseline (water treated sections) and experimental groups (formulation treated). All skin disinfection formulations were performed in triplicate.

### Data Analysis

Data were analyzed using STATA 9.0 (StataCorp, College Station, Tex.). Continuous data were analyzed using unpaired t tests. The means of the data from experiments conducted are presented. Error bars indicate standard error.

### RESULTS

### Alteration of pH Induces Sporicidal Activity in Alcohols

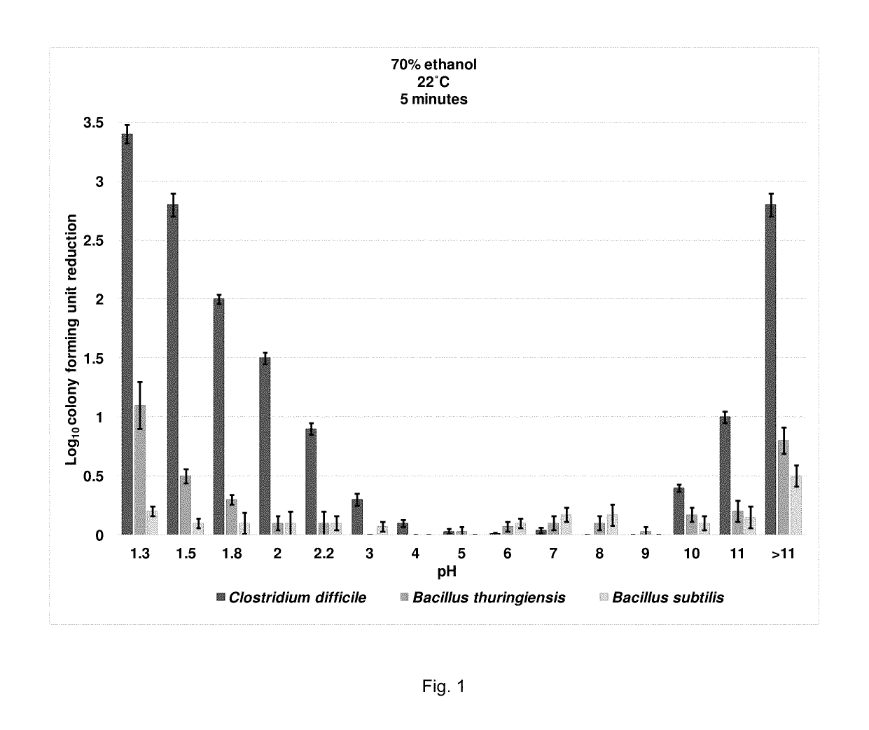

Dormant spores are resistant to killing by alcohol and acidic or basic conditions. However, alteration of pH may alter the killing efficacy of bactericidal agents. Therefore, we assessed the effect of alteration of pH on sporicidal activity of alcohols against C. difficile, B. thuringiensis, and B. subtilis spores. Three strains of C. difficile spores (VA11, VA17, and 43593) were reduced by ≧2 log₁₀CFU when exposed to 70% ethanol solutions adjusted to pH<2.2 or >11 for 5 minutes at room temperature (FIG. 1). C. difficile spores were significantly more susceptible to killing by acidic and basic ethanol solutions than either of the Bacillus spp. (P<0.001 for each comparison); B. thuringiensis spores were reduced by ˜1 log₁₀CFU when the pH of ethanol was adjusted to 1.3, whereas no significant reduction of B. subtilis spores was observed for any of the pH adjusted ethanol solutions.

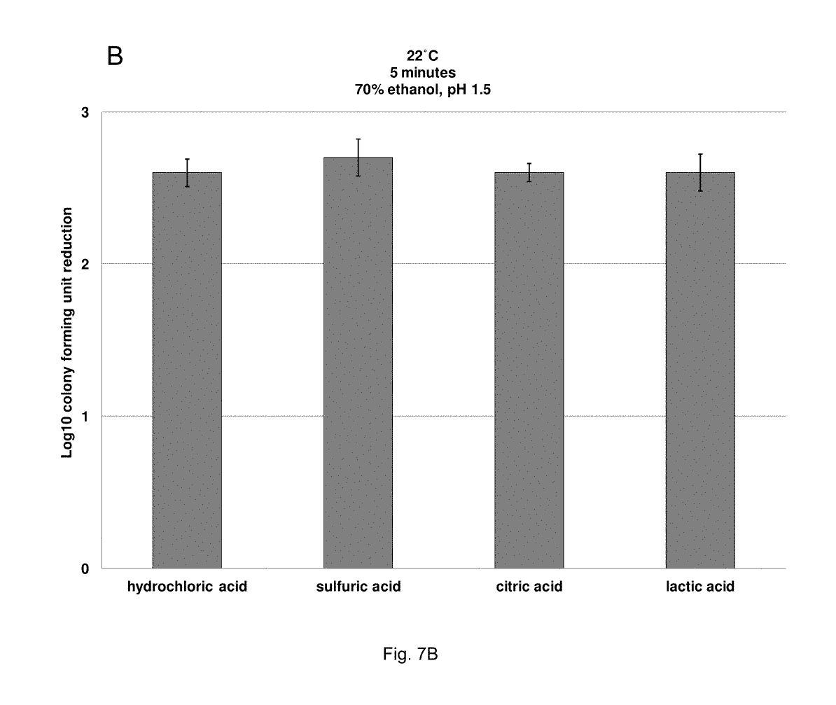

The sporicidal effects were not specific to ethanol. Acidification to pH<2 also induced sporicidal activity in 1-propanol (n-propanol) and 2-propanol (isopropanol) (FIG. 7A). In addition, similar results were achieved when the pH was reduced with other inorganic and organic acids, including sulfuric, lactic, and citric acids (FIG. 7B). Based on microscopic appearance, there was no evidence that reductions in spore counts were attributable to spore clumping. Because ethanol is the most common alcohol used for hand sanitizers in the U.S., we focused our remaining experiments on ethanol.

### Elevated Temperature Induces Sporicidal Activity in Ethanol

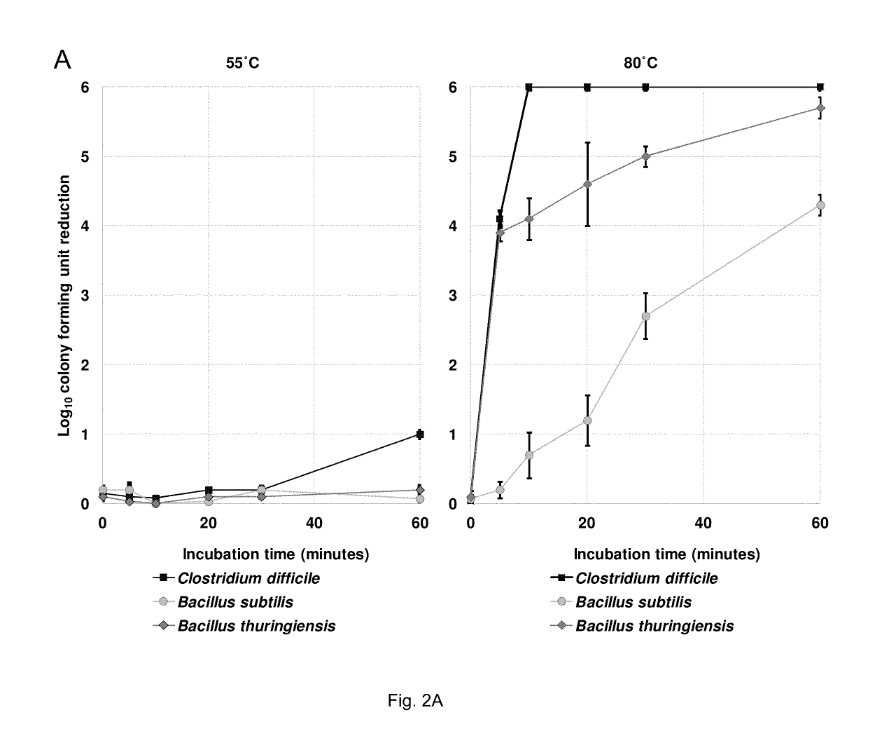

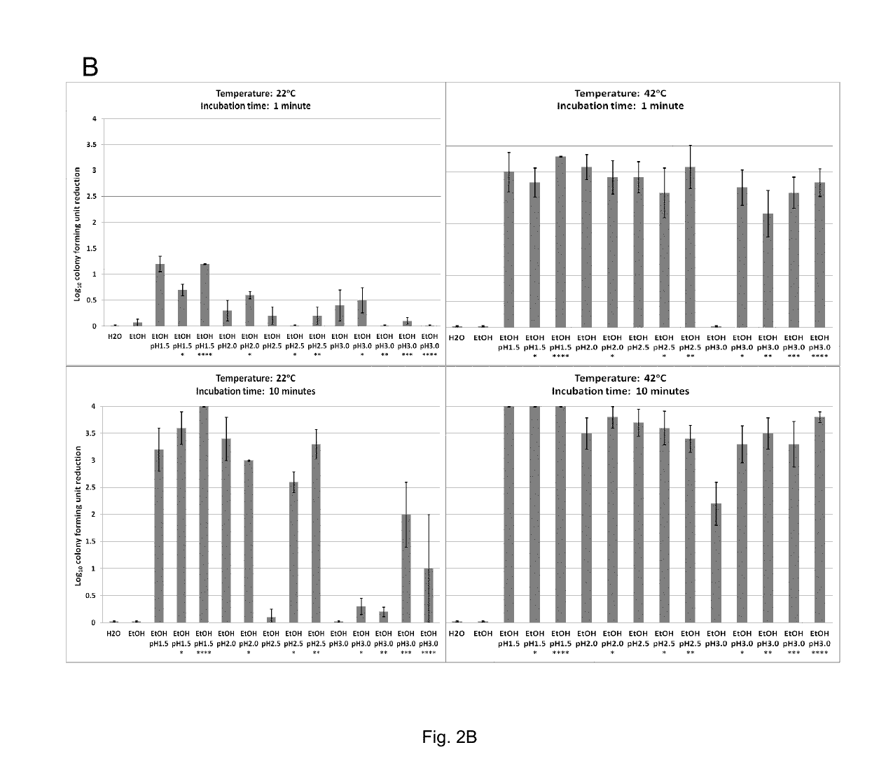

Increased temperatures of 55° C. or 80° C. enhance sporicidal activity of antiseptics such as chlorhexidine. We therefore examined the effect of these temperatures on sporicidal activity of ethanol with no pH alteration (FIG. 2A). All spores remained 100% viable suspended in water at about 22° C., 55° C., and 80° C. for up to 60 minutes (data not shown). However, at 55° C., C. difficile spores (strains VA11 and VA17) suspended in ethanol were reduced by 1 log₁₀CFU after 60 minutes. Killing of spores in ethanol was dramatically increased when the incubation temperature was elevated to 80° C., such that no C. difficile spores were detectable after 10 minutes of incubation, and after 60 minutes B. thuringiensis and B. subtilis were reduced by >5 and >4 log₁₀CFU, respectively. These results demonstrate the potential for elevated temperatures to enhance sporicidal activity of ethanol in the absence of pH alteration. However, the temperatures required to achieve sporicidal activity would not be tolerable on skin.

Mild Temperature Elevation and Increased Ionic Strength Enhance Sporicidal Activity of Acidified Ethanol Against C. difficile

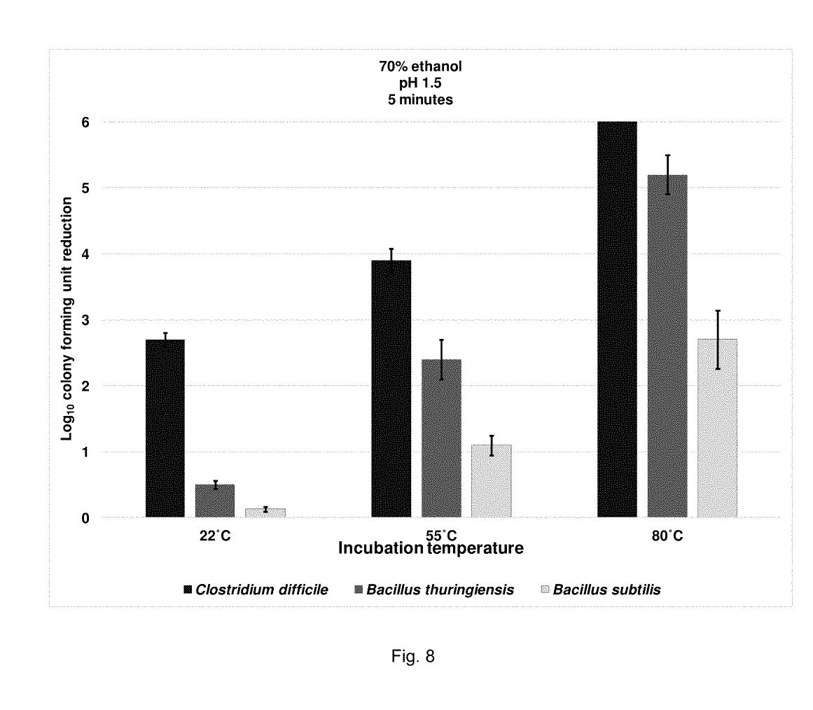

The sporicidal activity of acidified ethanol pH 1.5 was enhanced at 55° C. and 80° C., with a reduction in C. difficile spores of about 4 log₁₀CFU with a 5 minute exposure (FIG. 8). We therefore tested whether milder elevations of temperature that are tolerable on skin (≦42° C.) might enhance the sporicidal activity of acidified ethanol. In addition, we tested whether increased ionic strength might further enhance sporicidal activity of acidified ethanol. The rationale for testing solutions with increased ionic strength is that weak ionic bonds in proteins have been shown to be disrupted by solvents containing high ion concentrations (ionic strength), potentially weakening the links in proteinaceous material. Because alcohol hand sanitizers require rapid activity to be effective, we included an exposure time of 1 minute.

Increasing the ionic strength of acidified ethanol solutions and increased temperature of 42° C. enhanced sporicidal activity (FIG. 2b). At 22° C., increasing the ionic strength of acidified ethanol solutions significantly enhanced sporicidal activity after 10 minutes of incubation, but no enhancement occurred after 1 minute of incubation. Moreover, a buffered pH 2.5 ethanol solution (0.26N HCl, 0.26N NaOH) performed equivalently to unbuffered pH 1.5 ethanol (0.08N HCl, no NaOH); both solutions reduced C. difficile spores by >3 log₁₀CFU after 10 minutes of incubation.

At 42° C., the effects of increased ionic strength were masked by the synergistic effect of acidic pH and elevated temperature, with the exception of pH 3.0 solutions. After one minute of incubation at 42° C., spores exposed to pH 3.0 solutions without ionic strength buffering were not killed, whereas pH 3.0 solutions with increased ionic strength reduced C. difficile spore counts by >2 log₁₀CFU for each buffered solution assessed. Similarly, increasing the ionic strength of pH 3.0 solutions enhanced spore killing when incubated for ten minutes at 42° C.

Acidified Ethanol and Peracetic Acid Exert Synergistic Sporicidal Activity Against C. difficile and Bacillus spp. Spores

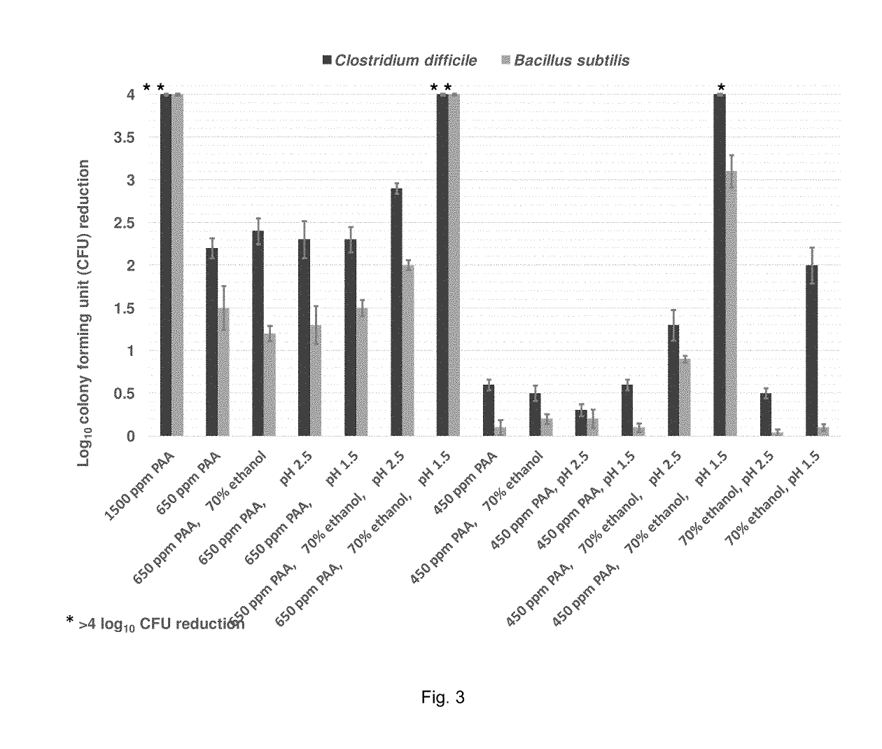

Peracetic acid is an oxidizing agent used for disinfection of hard surfaces and instruments. Although peracetic acid is toxic at high concentrations, it does not cause skin irritation at in-use concentrations of surface disinfectants (˜1500 ppm). With a 3 minute dwell time, peracetic acid at concentrations of 450, 650, and 1500 ppm reduced C. difficile and B. subtilis spores in a dose-dependent fashion. The addition of acidified ethanol to 450 and 650 ppm peracetic acid significantly enhanced killing of C. difficile and B. subtilis spores by >2 log₁₀CFU and >1 log₁₀CFU respectively, whereas peracetic acid with the addition of acid or ethanol alone did not similarly enhance killing (P<0.001 for each comparison) (FIG. 3).

We also tested several other compounds with antibacterial activity in combination with acidified ethanol. The addition of copper, iodine, sodium hypochlorite, and chlorine dioxide to acidified ethanol did not result in similar enhancement of sporicidal activity.

### Acidified Ethanol Solutions Alter Spore Inner Membrane Permeability

Previous studies have demonstrated that spores that are superdormant or treated with oxidizing agents may falsely present as nonviable because they germinate poorly on laboratory media. However, they can be stimulated to germinate in fluids such as blood, presumably by lysozyme in serum which assists in bypassing the normal germination machinery. Thus, we examined whether acidified ethanol truly kills spores or only renders them incapable of germination. There was no evidence that failure to recover spores was due to inactivation of germination machinery based on absence of recovery of killed spores with incubation in lysozyme which bypasses the normal germination machinery.

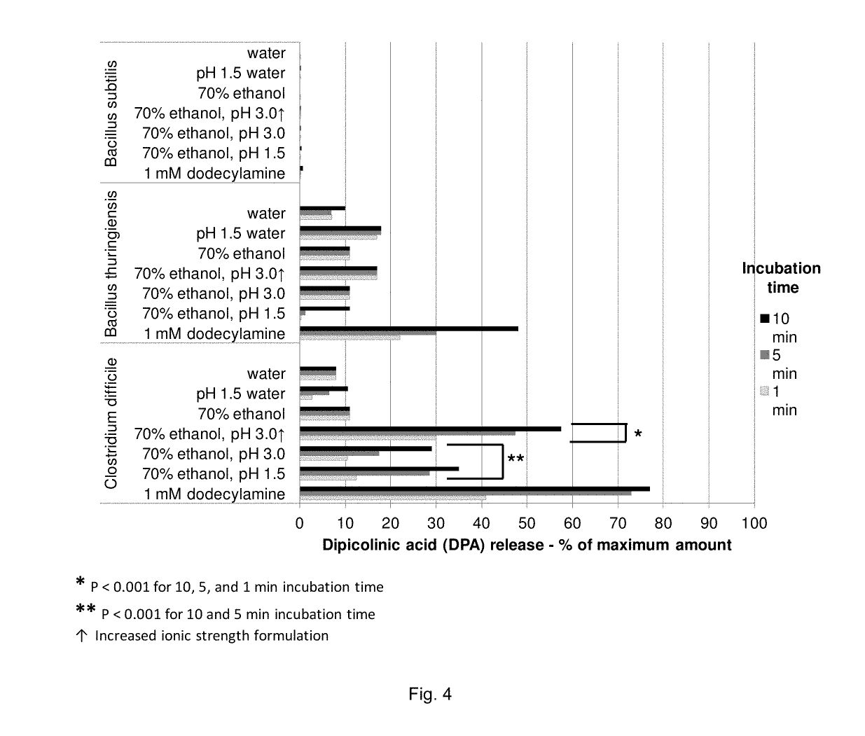

We next examined whether acidified ethanol kills spores through alteration in the permeability of the dormant spores' inner membrane barrier such that spore specific small molecules like dipicolinic acid (DPA) are released. Inner membrane permeation is the mechanism of killing of B. subtilis spores by strong acids, but the required exposure time is much longer than the exposure times required for killing of C. difficile spores by acidified ethanol. C. difficile DPA release was enhanced within 10 minutes of exposure to sporicidal acidified ethanol solutions when compared to water, 70% ethanol, and pH 1.5 water, which do not kill spores, suggesting that the mechanism of sporicidal activity may involve alteration of inner membrane permeability (FIG. 4). Notably, C. difficile and B. thuringiensis spores had low levels of baseline DPA release in water, pH 1.5 water, and 70% ethanol, whereas B. subtilis did not.

Acidified Ethanol Reduced Levels of C. difficile Spores on Skin

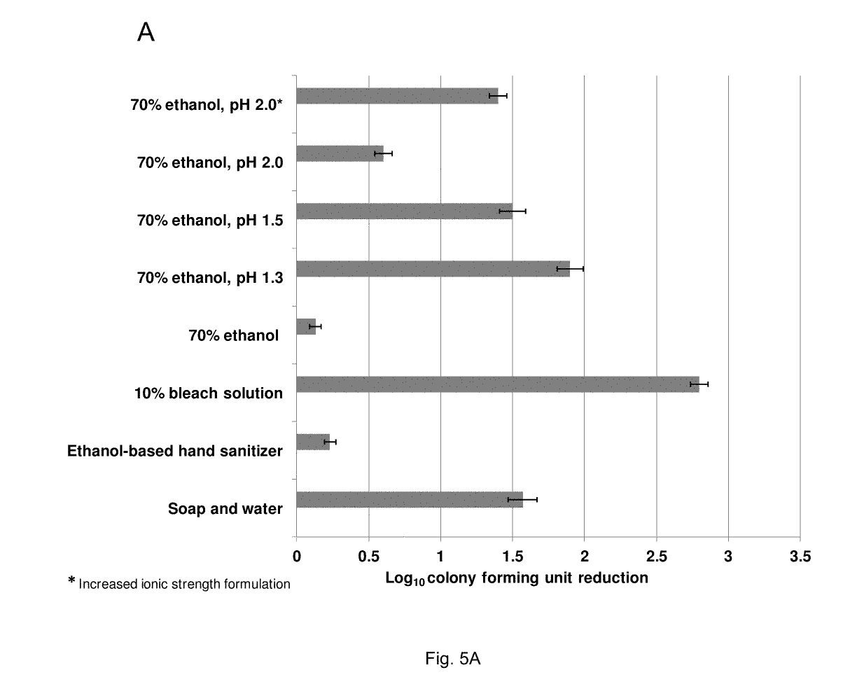

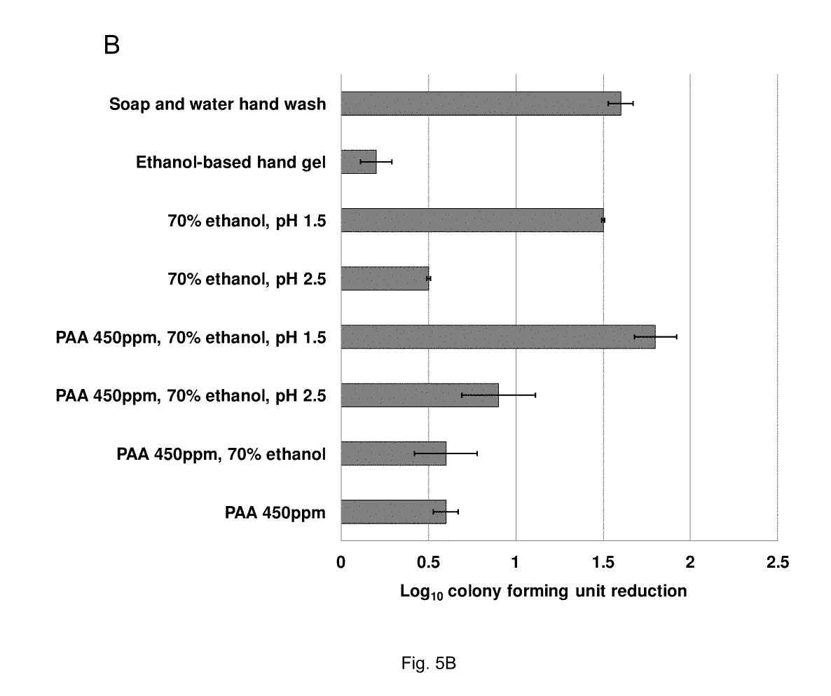

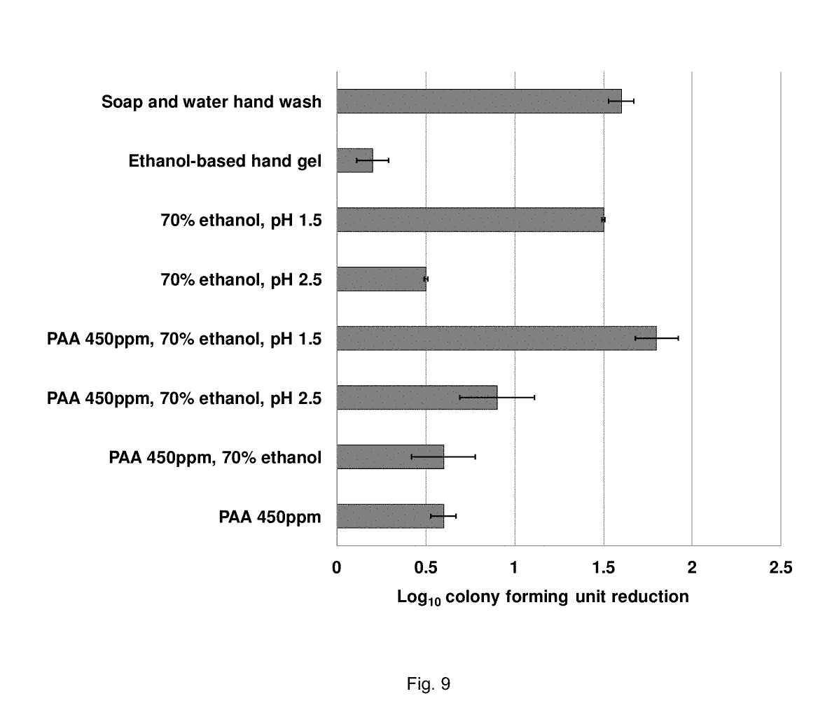

Acidified ethanol was effective in reducing recovery of C. difficile spores (nontoxigenic strain 43593) on hands with a 30 second exposure (FIG. 5a). A soap and water hand wash reduced C. difficile spores by ˜1.5 log₁₀CFU, whereas commercial ethanol-based hand sanitizer did not reduce spore counts. Ethanol adjusted to pH 1.5 was as effective as soap and water hand washing in reducing spore recovery from hands. Ethanol adjusted to pH 2.0 with increased ionic strength was also as effective as soap and water (˜1.5 log₁₀CFU reduction). The addition of dilute peracetic acid enhanced the effectiveness of acidified ethanol in reducing levels of C. difficile spores on hands (FIG. 5b). Moreover, increasing the exposure time to 60 seconds further enhanced sporicidal activity, with reductions of 2.5 to 3 log₁₀CFU. Similar results were achieved with a toxigenic C. difficile strain (VA17) using a porcine skin model (FIG. 9).

Here, we examined a novel strategy for development of sporicidal disinfectants whereby existing non-sporicidal disinfectants are converted into sporicidal agents through modifications that facilitate access to the spore core. We report successful induction of sporicidal activity in ethanol through acidification and further enhancement of activity through increasing ionic strength, mild temperature elevation, and addition of peracetic acid. Formulations of acidified ethanol were as effective as soap and water washing in reducing levels of C. difficile spores on skin with a 30 second exposure, and further enhancement was achieved with a 1 minute exposure. These findings suggest that it will be feasible to develop effective ethanol-based sporicidal hand hygiene products.

Acidified ethanol stimulated rapid release of DPA in C. difficile spores, suggesting that the mechanism of sporicidal activity involves alteration of inner membrane permeability. We propose that protein denaturation by the acidified ethanol solutions tested here facilitate rapid penetration of the spore coat, enabling ethanol and peracetic acid to reach targets within the spore core. This proposal is consistent with previous demonstrations that conditions that denature proteins may induce sporicidal activity in chlorhexidine and lysozyme. With the exception of peracetic acid, each of the modifications that induced or enhanced sporicidal activity are known to denature proteins. Acids and bases disrupt acidic and basic protein residues. High temperatures break hydrogen bonds and hydrophobic interactions in proteins. As noted previously, increased ionic strength may disrupt weak ionic bonds in proteins. Finally, ethanol itself is a protein denaturant that decreases the dielectric constant of water and changes electrostatic interactions in proteins. The potential for protein denaturation to induce sporicidal activity in ethanol is consistent with a recent report that mutation of the spore coat protein cotA of C. difficile results in a major defect in the outer spore coat that induces ethanol susceptibility. To minimize the potential for toxicity to skin, it is likely that an optimal approach for induction of sporicidal activity in ethanol will include a combination of denaturing processes.

Bacillus spores, particularly those of B. subtilis, were more resistant to killing by acidified ethanol solutions than C. difficile spores. The greater susceptibility of C. difficile could potentially be due to differences in protein structure of C. difficile versus Bacillus spp. spore coats; recent proteomic studies have revealed major differences in the spore coat and exosporium of C. difficile and Bacillus spp. spores. Although Bacillus spp. spores were relatively resistant to acidified ethanol, they were very susceptible to acidified ethanol in combination with peracetic acid, suggesting that this formulation will be effective against Bacillus spp. on skin. Differences in spore preparation technique, sporulation medium, and age of spores have previously been shown to effect the thermal resistance of C. difficile and Bacillus spp. spores. However, the C. difficile and B. thuringiensis spores used in the current study were prepared identically.

Although no adverse effects or discomfort were noted in the volunteers participating in hand hygiene experiments in the current study, safety and tolerability on skin will be important concerns for future development of acidified ethanol formulations. It is anticipated that acidic solutions with pH 2 or below may cause irritation and peeling of skin with repeated exposure. In healthy individuals, the skin surface is mildly acidic (pH 4 to 6) and has been termed an “acid mantle”. Mildly acidic skin products in the pH range 3.5 to 4.5 are considered optimal to preserve resident skin microbiota and function. We have demonstrated that pH 2.5 solutions can be as effective as soap and water hand washing. Nevertheless, in preliminary assessments, the addition of emollients to acidified ethanol pH 1.5 markedly reduced adverse effects on skin without compromising efficacy, suggesting that it may be feasible to develop effective and well-tolerated formulations at pH levels below 3.

### EXAMPLE 2

Clostridium difficile spores may be acquired on the hands of healthcare personnel during removal of contaminated gloves. Disinfection of gloves prior to removal could therefore be an effective strategy to reduce the risk for hand contamination. We tested the hypothesis that a novel, sporicidal formulation of acidified ethanol would be effective for rapid disinfection of C. difficile spores on gloves.

### METHODS

Reduction of toxigenic C. difficile spores inoculated on gloves of volunteers was compared after 30 or 60 second exposures to the sporicidal ethanol formulation, 70% ethanol, and 1:10 or 1:100 dilutions of household bleach; the solutions were applied both as a liquid solution and as a wipe. We also examined the efficacy of the sporicidal ethanol formulation for elimination of spore contamination from the gloves of healthcare personnel interacting with C. difficile infection (CDI) patients or their environment. To determine the potential for the disinfectants to damage clothing, the solutions were applied to pieces of colored cloth.

### RESULTS

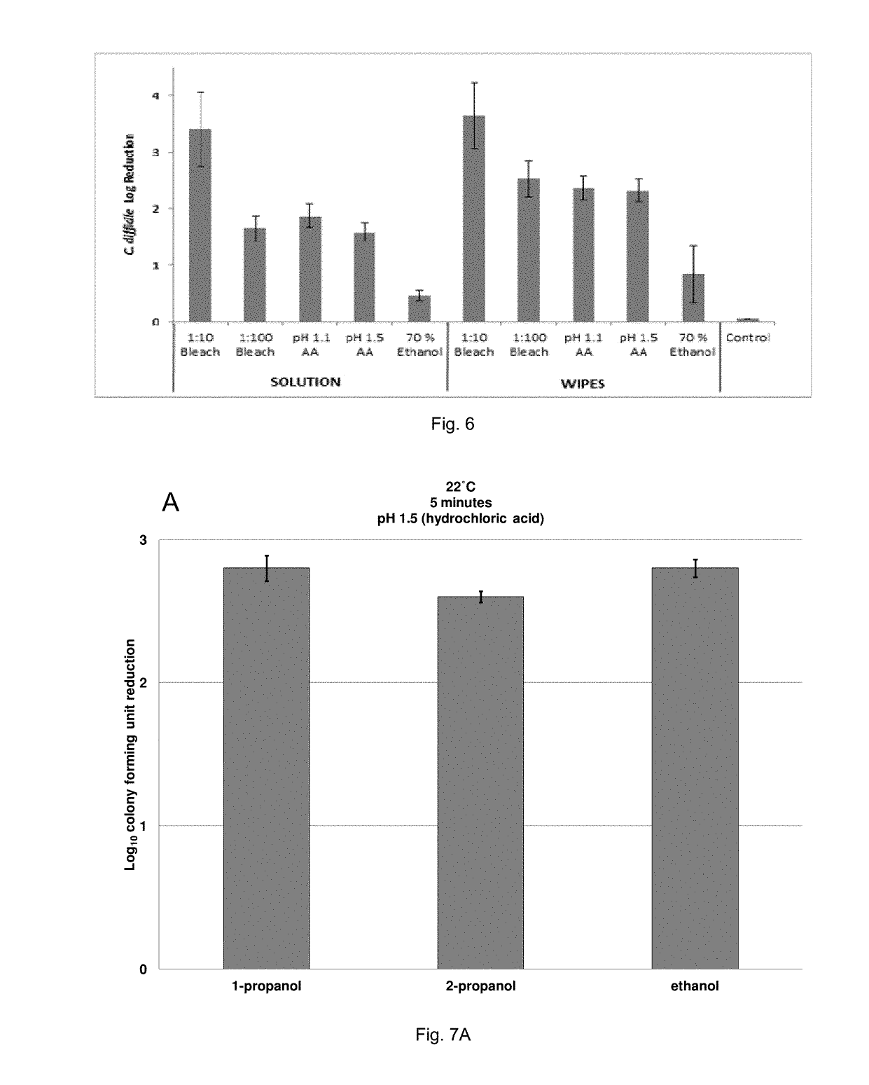

In 30 and 60 second liquid applications, the sporicidal ethanol formulation reduced spore levels by 1.4 logs and 2 logs, respectively (P<0.0001); 30 and 60 second wipe application resulted in 2 and >2.5 log reductions, respectively (FIG. 6). 70% ethanol applied as a liquid or wipe resulted in a <1 log reduction in spores. Reductions achieved with a 1:100 dilution of bleach were equivalent to the sporicidal ethanol solution, whereas a 1:10 dilution was more effective (>3 log reduction). However, both bleach solutions stained clothing, while the sporicidal ethanol solution did not. The sporicidal ethanol solution was as effective as a 1:100 dilution of bleach for elimination of spore contamination acquired on gloves of healthcare personnel.

### EXAMPLE 3

Alcohol-based hand sanitizers are primary method of hand hygiene in healthcare settings, but they lack activity against bacterial spores produced by pathogens such as Clostridium difficile and Bacillus anthracis. We previously demonstrated that acidification of ethanol induced rapid sporicidal activity, resulting in ethanol formulations with pH 1.5 to 2 that were as effective as soap and water washing in reducing levels of C. difficile spores on hands. We hypothesized that the addition of dilute peracetic acid (PAA) to acidified ethanol would enhance sporicidal activity while allowing elevation of the pH to a level likely to be well-tolerated on skin.

### METHODS

We tested the efficacy of acidified ethanol solutions alone or in combination with PAA against C. difficile and B. subtilis spores in vitro and against nontoxigenic C. difficile spores on hands of volunteers.

### Spore Strains and Growth Conditions

Two C. difficile strains cultured from patients with CDI in Cleveland and one strain purchased from the American Type Culture Collection (ATCC) were used. VA 17 is an epidemic (cdtB+) restriction endonuclease analysis (REA) BI strain and VA 11 is a non-epidemic (cdtB−) REA J strain; both isolates are toxigenic (tcdA+, tcdB+) strains. ATCC 43593 is a non-toxigenic (tcdA, tcdB−) strain from serogroup B. C. difficile cultures were incubated at 37° C. for 48 hours in a Whitley MG1000 anaerobic workstation (Microbiology International, Frederick, Md.) on pre-reduced cycloserine-cefoxitin-brucella agar containing 0.1% taurocholic acid and lysozyme 5 mg/L (CDBA).

B. subtilis 168 was donated by Peter Setlow (UConn Health Center, Farmington, Conn.). Strain 168 spores were cultured on trypticase soy agar containing 5% sheep blood (Becton Dickinson, Franklin Lakes, N.J.) under aerobic conditions at 37° C. for 24 hours.

### Preparation of Spores

C. difficile spores were prepared as previously described. In brief, pre-reduced brain-heart infusion plates were spread with 100 μl of a 24 hour C. difficile suspension and incubated for one week in an anaerobic incubator. Spores were harvested from the plates using sterile swabs and 8 mL of ice-cold, sterile, distilled water. Spores were washed five times by centrifuging and re-suspending in distilled water. Vegetative material was removed by density gradient centrifugation in Histodenz (Sigma Aldrich, St. Louis, Mo.). Prior to testing, spore preps were confirmed by phase contrast microscopy and malachite green staining to be >99% dormant, bright-phase spores.

B. subtilis spores were prepared at 37° C. on 2×SG medium agar plates and harvested, cleaned, and stored as previously described. Spores were separated from vegetative material by density gradient centrifugation in Nycodenz (Axis-Shield, Oslo, Norway). Spores were confirmed by phase contrast microscopy and malachite green staining to be >99% dormant, bright-phase spores.

### The Effect of Acidic pH on Sporicidal Activity of Ethanol

We previously demonstrated that reducing the pH of 70% ethanol to pH 1.3-2.0 induced rapid sporicidal activity against C. difficile at room temperature. However B. subtilis spores remained resistant to killing at this pH range. To determine whether sporicidal activity could be induced in ethanol against the more resistant B. subtilis spores, the pH of 70% ethanol and deionized water (acid control) was reduced further with hydrochloric acid to a pH range of 0.8 to 4. Ten microliters of B. subtilis and C. difficile spores (˜10⁶ CFU) were incubated for five minutes in one mL of the pH adjusted ethanol or water at 22° C. The reaction was quenched by neutralizing 1:1 in Dey-Engley neutralization broth (BD Biosciences, San Jose, Calif.). Neutralized samples were serially diluted in deionized water, drop-plated, and cultured as described previously. To increase the sensitivity of enumeration for samples with high levels of spore killing, 1 mL of the neutralized spore suspensions were spread-plated. Following incubation, log₁₀CFU reduction of spores was determined by calculating the difference in log₁₀CFU recovered from baseline (pH altered water) and experimental groups (pH altered ethanol).

Efficacy of Aqueous Versus Alcoholic PAA for Killing of C. difficile Spores

The effect of ethanol on the sporicidal activity of dilute PAA was assessed for C. difficile strains VA 17 and ATCC 43593. PAA solutions were prepared to a final concentration of 450 ppm in sterile deionized water or 70% ethanol. Final PAA concentrations were measured using a peracetic acid titration kit (LaMotte Company, Chestertown, Md.). The pH of the solutions was left unaltered (about pH 3.5) or adjusted with hydrochloric acid (pH 3.0, 2.5, 2.0, 1.5, and 1.0). Ten μL of spores (about 10⁶ CFU) were inoculated into one mL of water (baseline), pH adjusted ethanol (pH 2.5 and 1.5), and PAA solutions and incubated at room temperature for 3 minutes. The reaction was quenched by neutralizing 1:1 in Dey-Engley neutralization broth. Neutralized samples were serial diluted in deionized water, drop-plated, and cultured as described previously. Following incubation, log₁₀CFU reduction of spores was determined by calculating the difference in log₁₀CFU recovered from baseline (water) and experimental groups. Experiments were performed in triplicate.

### Effect of Dilute PAA on Sporicidal Activity of Acidified Ethanol

The effect of the addition of dilute PAA on the activity of acidified ethanol against C. difficile strain VA17 and B. subtilis was tested at 22° C. The pH of specified test solutions was adjusted to 2.5 or 1.5 with hydrochloric acid. Ten μL of spores (˜10⁶ CFU) were inoculated into one mL of water (baseline), pH adjusted ethanol, PAA at 450, 650, or 1500 ppm, pH adjusted PAA at 450 and 650 ppm, ethanol plus PAA at 450 and 650 ppm, and pH adjusted ethanol plus PAA at 450 and 650 ppm and incubated for 3 minutes. The reaction was quenched by neutralizing 1:1 in Dey-Engley neutralization broth. Neutralized samples were serial diluted in deionized water, drop-plated, and cultured as described previously. Following incubation, log₁₀CFU reduction of spores was determined by calculating the difference in log₁₀CFU recovered from baseline (water) and experimental groups. Experiments were performed in triplicate.

Efficacy of Dilute PAA and Acidified Ethanol Solutions for Reducing C. difficile Spores on Hands

A modification of the “Standard Test Method for Determining the Bacteria-Eliminating Effectiveness of Hygienic Handwash and Handrub Agents Using the Fingerpads of Adults” (American Society for Testing and Materials E 2276-10) was used to determine the efficacy of test solutions against non-toxigenic C. difficile spores. Each fingerpad of both hands were contaminated with 10 μL of a liquid inoculum containing 6 log₁₀CFU of ATCC 43593 spores. The fingerpads were rubbed together until the inoculum was dry. Hand contamination levels were measured using a modified fingerpad sampling method. The fingerpads of each hand were rubbed with slight friction against the bottom of a 150 mm×15 mm Petri dish filled with 25 mL of Dey-Engley neutralizer for 30 seconds. The neutralizer was collected from the Petri dish, serially diluted, and plated on CDBA media to determine C. difficile counts. Log₁₀ reductions were calculated by subtracting log₁₀ CFU recovered after hand hygiene treatment from log₁₀ CFU recovered from hands without treatment.

A crossover design was used such that each volunteer was exposed to 1 of the 10 disinfection procedures no more than once every 24 hours. The order of the hand disinfection procedures for each volunteer was assigned using a computer-generated random numbers list designed to allow all agents or procedures to be tested six times. The person reading the plates was blinded to the test product. The hand disinfection interventions included 1 mL ethanol-based hand sanitizer gel (Purell, GOJO Industries, Akron, Ohio), 1 mL of 0.05% triclosan liquid soap (STERIS Corporation, Mentor, Ohio), 1 mL of 450 ppm PAA (unaltered pH ˜3.0), and 1 mL of the following ethanol-based solutions: 70% ethanol pH 2.5, 70% ethanol pH 1.5, 70% ethanol plus 450, 1200, or 2000 ppm PAA (unaltered pH>3.0), 70% ethanol pH 1.5 plus 450 ppm PAA, and 70% ethanol pH 2.5 plus 450 ppm PAA. For the soap and water handwash, fingerpads were rubbed vigorously with liquid soap for 20 sec, rinsed with water until soap was completely removed, and patted dry with paper towels. For the PAA and ethanol-based handrub agents, fingerpads were rubbed together until dry.

### Data Analysis

Data were analyzed with R statistical software (version 3.1,1). Continuous data were analyzed using unpaired t tests. For skin model experiments, one-way ANOVA was performed to compare the mean log reductions. A post hoc Tukey HSD test was conducted to test all pairwise differences between group means.

### RESULTS

Acidification of ethanol induced rapid sporicidal activity against C. difficile, and to a lesser extent B. subtilis. The addition of dilute PAA to acidified ethanol resulted in synergistic enhancement of sporicidal activity in a dose dependent fashion in vitro. On hands, the addition of PAA enhanced the effectiveness of acidified ethanol formulations, resulting in formulations with pH greater than 3 that were as effective as soap and water washing.

### Acidification Induces Sporicidal Activity in Alcohol

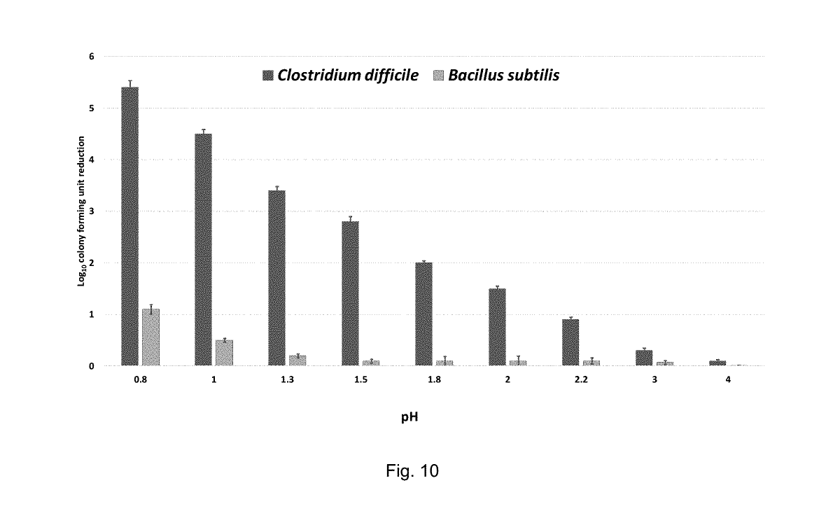

C. difficile and B. subtilis spores were not killed in water adjusted to pH 0.8-4.0. There were no significant differences between the log₁₀CFU reductions of the 3 strains of C. difficile tested (VA11, VA17, and 43593); therefore, data for the strains were pooled. With a 5 minute dwell time, C. difficile spores were reduced in a dose-dependent fashion as the concentration of acid was increased (FIG. 10). A ≧2 log₁₀CFU reduction of C. difficile spores was observed when ethanol solutions were adjusted to pH<2.0 at room temperature. C. difficile spores were significantly more susceptible to killing by acidified ethanol solutions than B. subtilis spores (P<0.001). B. subtilis spores were reduced by ˜1 log₁₀CFU when the pH of ethanol was adjusted to 0.8, but no significant reduction of B. subtilis spores was observed for any of the other pH adjusted solutions.

### Ethanol Enhances the Sporicidal Efficacy of Dilute PAA

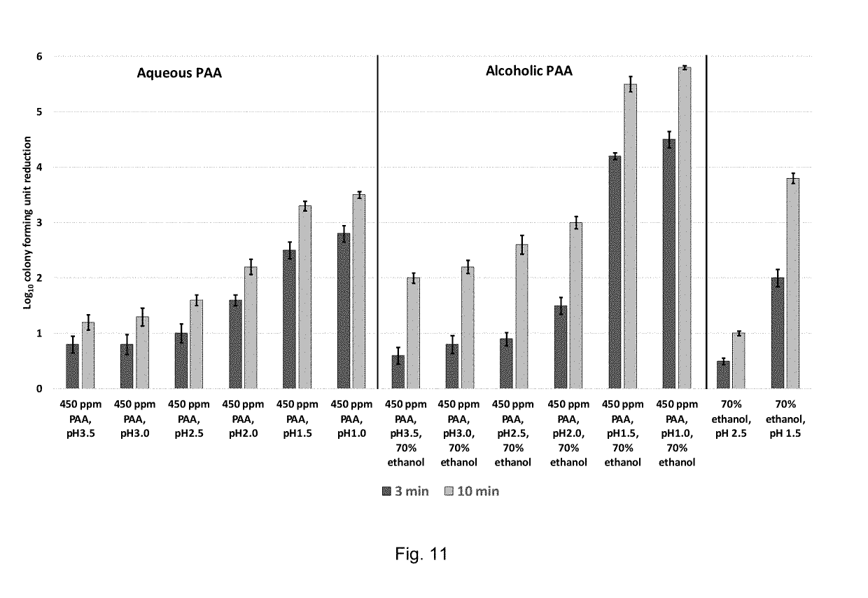

There were no significant differences between the log₁₀CFU reductions of the two strains of C. difficile tested (VA17 and ATCC 43593); therefore, data for the strains were pooled. After 3 minutes of incubation, the presence of ethanol significantly enhanced the activity of dilute PAA (450 ppm) at pH 1.5 and 1.0 (P<0.01 for aqueous versus alcoholic PAA at pH 1.5 and 1.0) (FIG. 11). However, PAA solutions with a pH>1.5 were unaffected by the presence of ethanol.

After 10 minutes of incubation, ethanol significantly enhanced the sporicidal activity of PAA solutions for all pHs assessed, including PAA with no added HCl at pH 3.5 (P<0.01 for each comparison). The degree to which ethanol enhanced the sporicidal activity of PAA solutions increased as the pH was lowered (i.e. ˜0.5 log₁₀CFU reduction for pH 3.5 alcoholic PAA solutions and ˜2 log₁₀ CFU reduction for pH 1.5 alcoholic PAA solutions).

Acidified Ethanol and Dilute PAA Exert Synergistic Sporicidal Activity Against C. difficile and B. subtilis Spores

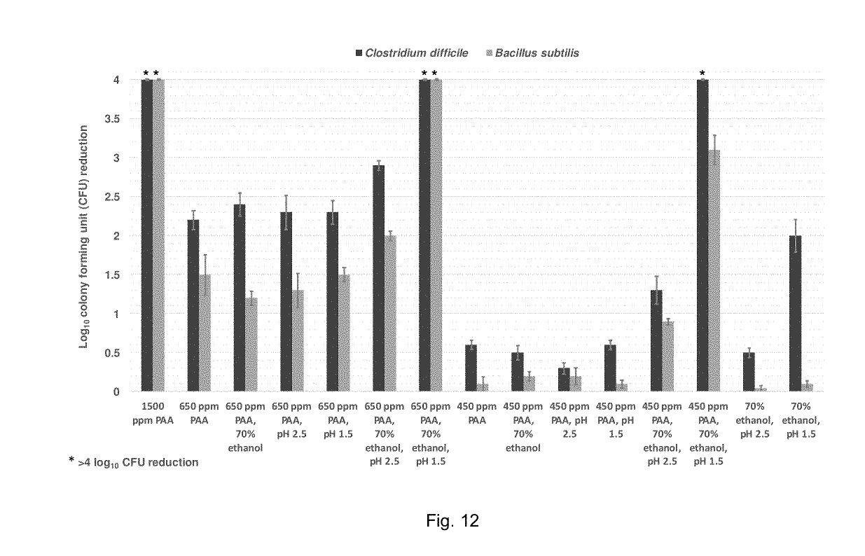

With a 3 minute dwell time, PAA at concentrations of 450, 650, and 1500 ppm (pH ˜3.5) reduced C. difficile and B. subtilis spores in a dose-dependent fashion (FIG. 12). The addition of acidified ethanol to 450 and 650 ppm PAA significantly enhanced killing of C. difficile and B. subtilis spores by >2 log₁₀CFU and >1 log₁₀CFU, respectively (P<0.001 for each comparison), whereas PAA with the addition of acid (pH 1.5 or 2.5) alone or ethanol alone did not similarly enhance killing.

Acidified Ethanol and Dilute PAA Reduce Levels of C. difficile Spores on Skin

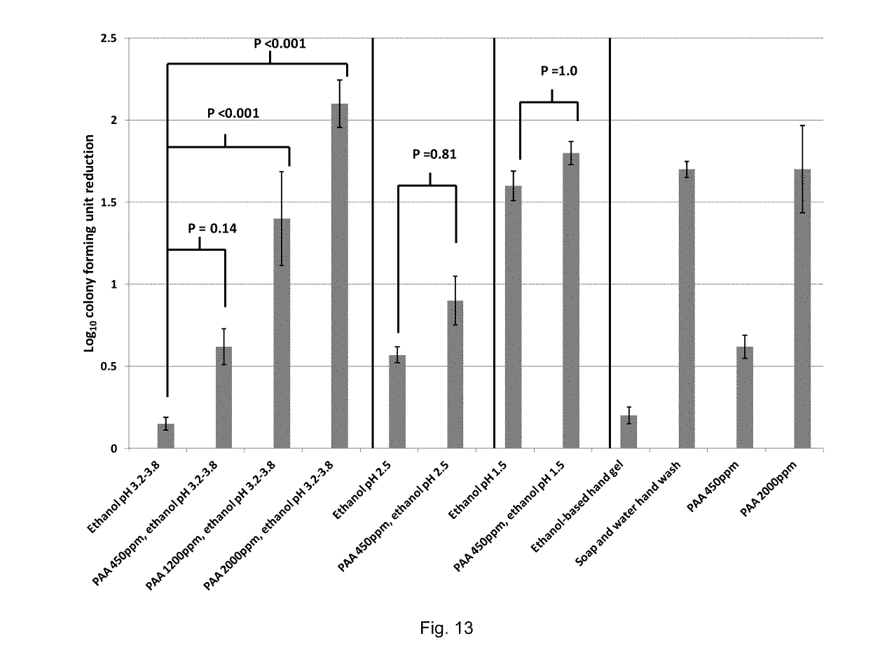

A soap and water hand wash reduced C. difficile spores by ˜1.7 log₁₀CFU, whereas commercial ethanol-based hand sanitizer did not (FIG. 13). At pH 1.5, 2.5, and 3.2-3.8, the addition of PAA 450 ppm to acidified ethanol resulted in a modest but consistent reduction in spore recovery; however, the differences were not statistically significant. At pH 3.2-3.8, the addition of PAA at 1200 or 2000 ppm significantly enhanced reductions in C. difficile spores versus ethanol at pH 3.2-3.8. The reduction by 2000 ppm PAA plus acidifed ethanol pH 3.2-3.8 was not significantly greater than the reduction by 2000 ppm PAA alone (P>0.05). The reductions in C. difficile spores achieved by ethanol pH 1.5, PAA 450 ppm plus ethanol pH 1.5, PAA 1200 ppm plus ethanol pH 3.2-3.8, PAA 2000 ppm plus ethanol pH 3.2-3.8, and PAA 2000 ppm were not significantly different from the reduction by soap and water hand wash (P>0.05).

From the above description of the invention, those skilled in the art will perceive improvements, changes and modifications. Such improvements, changes and modifications within the skill of the art are intended to be covered by the appended claims. All references, publications, and patents cited in the present application are herein incorporated by reference in their entirety.

Having described the invention, We claim:

1. A sporicidal composition comprising an acidified short or medium chain, linear or branched alcohol having a pH effective to promote killing of spore forming bacteria and bacterial spores, the composition including at least about 70% by weight of the alcohol, and having a pH less than about 3.5.

2. The composition of claim 1, the composition capable of disrupting the inner membrane barrier of bacterial spores.

3. The composition of claim 1, wherein the pH is tolerable to human skin.

4. The composition of claim 3, wherein the pH is less than about 3.

5. The composition of claim 1, wherein the alcohol comprises ethanol and/or propanol.

6. The composition of claim 1, further comprising peracetic acid.

7. The composition of claim 1, further comprising an ion forming agent.

8. The composition of claim 1, wherein the composition is buffered with sodium hydroxide to increase the ionic strength of the composition.

9. The composition of claim 1, wherein the composition is effective at promoting killing of C. difficile spores.

10. The composition of claim 1, wherein the composition is effective at promoting killing of Bacillus spp. spores.

11. A method of reducing the number of and/or killing C. difficile spores on a C. difficile spore-contaminated surface, the method comprising:
applying to the spore contaminated surface a sporicidal composition comprising an amount of an acidified short or medium chain, linear or branched alcohol having a pH effective to promote killing of spore forming bacteria and bacterial spores, the composition including at least about 70% by weight of the alcohol, and having a pH less than about 3.5.

12. The method of claim 11, the composition capable of disrupting the inner membrane barrier of bacterial spores.

13. The method of claim 11, wherein the pH is tolerable to human skin.

14. The method of claim 11, wherein the pH is less than about 3.

15. The method of claim 11, wherein the alcohol comprises ethanol and/or propanol.

16. The method of claim 11, further comprising peracetic acid.

17. The method of claim 11, further comprising an ion forming agent.

18. The method of claim 11, wherein the composition is buffered with sodium hydroxide to increase the ionic strength of the composition.

19. The method of claim 11, wherein the spore-contaminated surface comprises at least one of a part of a piece of furniture, table or countertop, floor, wall, bath or lavatory surfaces, bedclothes, linens, human skin, or a part of a medical device or instrument.

20. The method of claim 11, wherein the sporicidal composition is applied to the spore-contaminated surface by immersion bath, wiping or washing.
